(19) United States
(12) Patent Application Publication
(10) Pub. No.: US 2025/0081074 A1
(43) Pub. Date: Mar. 6, 2025

(54) CONDITIONAL HANDOVER AND SELECTIVE SECONDARY CELL GROUP ACTIVATION

(71) Applicant: QUALCOMM Incorporated, San Diego, CA (US)

(72) Inventors: Rajeev KUMAR, San Diego, CA (US); Shankar KRISHNAN, San Diego, CA (US); Punyaslok PURKAYASTHA, San Diego, CA (US)

(21) Appl. No.: 18/458,695

(22) Filed: Aug. 30, 2023

(51) Int. Cl. H04W 36/36; H04W 24/04; H04W 36/00; H04W 36/30

(52) U.S. Cl. CPC H04W 36/362; H04W 24/04; H04W 36/0069; H04W 36/0079; H04W 36/305

(57) ABSTRACT

Various aspects of the present disclosure generally relate to wireless communication. In some aspects, a user equipment (UE) may obtain an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change. The UE may initiate the selective secondary cell group activation or the subsequent conditional handover. The UE may detect a failure occurrence associated with the selective secondary cell group activation or the subsequent conditional handover. The UE may transmit, in accordance with detecting the failure occurrence associated with the selective secondary cell group activation or the subsequent conditional handover, information associated with the selective secondary cell group activation or the subsequent conditional handover. Numerous other aspects are described.

### FIELD OF THE DISCLOSURE

Aspects of the present disclosure generally relate to wireless communication and to techniques and apparatuses for conditional handover and selective secondary cell group activation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes obtaining an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change; initiating the selective secondary cell group activation or the subsequent conditional handover; detecting a failure occurrence associated with the selective secondary cell group activation or the subsequent conditional handover; and transmitting, in accordance with detecting the failure occurrence associated with the selective secondary cell group activation or the subsequent conditional handover, information associated with the selective secondary cell group activation or the subsequent conditional handover.

In some aspects, a method of wireless communication performed by a network node includes identifying a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and transmitting a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error.

In some aspects, a method of wireless communication performed by a UE includes obtaining an indication to perform a conditional handover in accordance with a conditional handover configuration with a plurality of conditional primary secondary cell change configurations or a plurality of conditional primary secondary cell addition configurations; initiating the conditional handover and at least one of a conditional primary secondary cell change associated with the plurality of conditional primary secondary cell change configurations or a conditional primary secondary cell addition associated with the plurality of conditional primary secondary cell addition configurations; detecting a failure occurrence associated with the conditional handover, or at least one of the conditional primary secondary cell change or the conditional primary secondary cell addition; and transmitting, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations.

In some aspects, a method of wireless communication performed by a UE includes identifying an error during a conditional handover execution with a plurality of conditional primary secondary cell change or a plurality of conditional primary secondary cell addition; and transmitting information that indicates the error during the execution of conditional handover with the plurality of conditional primary secondary cell change configurations or the plurality of conditional primary secondary cell addition configurations, or that indicates a radio link failure at the primary cell after a successful conditional handover or at a primary secondary cell after the successful execution of the plurality of conditional primary secondary cell changes or the plurality of conditional primary secondary cell additions.

In some aspects, a UE for wireless communication includes one or more memories; and one or more processors, coupled to the one or more memories, the one or more processors individually or collectively configured to cause the UE to: obtain an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change; initiate the selective secondary cell group activation or the subsequent conditional handover; detect a failure occurrence associated with the selective secondary cell group activation or the subsequent conditional handover; and transmit, in accordance with detecting the failure occurrence associated with the selective secondary cell group activation or the subsequent conditional handover, information associated with the selective secondary cell group activation or the subsequent conditional handover.

In some aspects, a network node for wireless communication includes one or more memories; and one or more processors, coupled to the one or more memories, the one or more processors individually or collectively configured to cause the network node to: identify a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and transmit a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error.

In some aspects, a UE for wireless communication includes one or more memories; and one or more processors, coupled to the one or more memories, the one or more processors individually or collectively configured to cause the UE to: obtain an indication to perform a conditional handover in accordance with a conditional handover configuration with a plurality of conditional primary secondary cell change configurations or a plurality of conditional primary secondary cell addition configurations; initiate the conditional handover and at least one of a conditional primary secondary cell change associated with the plurality of conditional primary secondary cell change configurations or a conditional primary secondary cell addition associated with the plurality of conditional primary secondary cell addition configurations; detect a failure occurrence associated with the conditional handover, or at least one of the conditional primary secondary cell change or the conditional primary secondary cell addition; and transmit, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations.

In some aspects, a UE for wireless communication includes one or more memories; and one or more processors, coupled to the one or more memories, the one or more processors individually or collectively configured to cause the UE to: identify an error during a conditional handover execution with a plurality of conditional primary secondary cell changes or a plurality of conditional primary secondary cell additions; and transmit information that indicates the error during the execution of conditional handover with the plurality of conditional primary secondary cell change configurations or the plurality of conditional primary secondary cell addition configurations, or that indicates a radio link failure at the primary cell after the successful conditional handover or at the primary secondary cell after the successful execution of the plurality of conditional primary secondary cell changes or the plurality of conditional primary secondary cell additions.

In some aspects, a non-transitory computer-readable medium storing a set of instructions for wireless communication includes one or more instructions that, when executed by one or more processors of a UE, cause the UE to: obtain an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change; initiate the selective secondary cell group activation or the subsequent conditional handover; detect a failure occurrence associated with the selective secondary cell group activation or the subsequent conditional handover; and transmit, in accordance with detecting the failure occurrence associated with the selective secondary cell group activation or the subsequent conditional handover, information associated with the selective secondary cell group activation or the subsequent conditional handover.

In some aspects, a non-transitory computer-readable medium storing a set of instructions for wireless communication includes one or more instructions that, when executed by one or more processors of a network node, cause the network node to: identify a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and transmit a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error.

In some aspects, a non-transitory computer-readable medium storing a set of instructions for wireless communication includes one or more instructions that, when executed by one or more processors of a UE, cause the UE to: obtain an indication to perform a conditional handover in accordance with a conditional handover configuration with a plurality of conditional primary secondary cell change configurations or a plurality of conditional primary secondary cell addition configurations; initiate the conditional handover or at least one of a conditional primary secondary cell change associated with the plurality of conditional primary secondary cell change configurations or a conditional primary secondary cell addition associated with the plurality of conditional primary secondary cell addition configurations; detect a failure occurrence associated with the conditional handover, or at least one of the conditional primary secondary cell change or the conditional primary secondary cell addition; and transmit, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations.

In some aspects, a non-transitory computer-readable medium storing a set of instructions for wireless communication includes one or more instructions that, when executed by one or more processors of a UE, cause the UE to: identify an error during a conditional handover execution with a plurality of conditional primary secondary cell change or a plurality of conditional primary secondary cell addition; and transmit information that indicates the error during the conditional handover execution with the plurality of conditional primary secondary cell change or the plurality of conditional primary secondary cell addition.

In some aspects, an apparatus for wireless communication includes means for obtaining an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change; means for initiating the selective secondary cell group activation or the subsequent conditional handover; means for detecting a failure occurrence associated with the selective secondary cell group activation or the subsequent conditional handover; and means for transmitting, in accordance with detecting the failure occurrence associated with the selective secondary cell group activation or the subsequent conditional handover, information associated with the selective secondary cell group activation or the subsequent conditional handover.

In some aspects, an apparatus for wireless communication includes means for identifying a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and means for transmitting a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error.

In some aspects, an apparatus for wireless communication includes means for obtaining an indication to perform a conditional handover in accordance with a conditional handover configuration with a plurality of conditional primary secondary cell change configurations or a plurality of conditional primary secondary cell addition configurations; means for initiating the conditional handover and at least one of a conditional primary secondary cell change associated with the plurality of conditional primary secondary cell change configurations or a conditional primary secondary cell addition associated with the plurality of conditional primary secondary cell addition configurations; means for detecting a failure occurrence associated with the conditional handover, or at least one of the conditional primary secondary cell change or the conditional primary secondary cell addition; and means for transmitting, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations.

In some aspects, an apparatus for wireless communication includes means for identifying an error during a conditional handover execution with a plurality of conditional primary secondary cell change or a plurality of conditional primary secondary cell addition; and means for transmitting information that indicates the error during the conditional handover execution with the plurality of conditional primary secondary cell changes or the plurality of conditional primary secondary cell additions.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating examples of conditional handovers, in accordance with the present disclosure.

FIG. 5 is a diagram illustrating an example of selective secondary cell group activation and subsequent conditional handover configurations, in accordance with the present disclosure.

FIG. 6 is a diagram illustrating an example of subsequent conditional handover failure and selective secondary cell group activation failure indication, in accordance with the present disclosure.

FIGS. 7A-7B are diagrams illustrating examples of selective secondary cell group configurations and conditional handover configurations, in accordance with the present disclosure.

FIG. 8 is a diagram illustrating an example of conditional handover signaling, in accordance with the present disclosure.

FIG. 9 is a diagram illustrating an example of conditional handover signaling with multiple conditional primary cell change or conditional primary cell addition configurations, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram illustrating an example process performed, for example, at a UE or an apparatus of a UE, in accordance with the present disclosure.

FIG. 13 is a diagram illustrating an example process performed, for example, at a UE or an apparatus of a UE, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

A user equipment (UE) may perform a handover to switch between a first network node and a second network node. A conditional handover may be a handover that is performed by the UE in accordance with one or more conditions, such as a signal strength, signal quality, or load balancing, among other examples, being satisfied. The conditional handover may be associated with a conditional primary cell change, which may include the UE switching from a first primary cell to a second primary cell, or may be associated with a primary cell addition, which may include the UE adding a second primary cell. The UE may perform a secondary cell group activation by activating additional secondary cell groups (e.g., frequency bands or frequency band groups), for example, to improve network capacity, data speed, and overall network performance.

In some cases, the UE may receive a single reference configuration for performing a selective secondary cell group activation or a subsequent conditional handover associated with a subsequent conditional primary cell change or addition, or may receive multiple reference configurations for performing the selective secondary cell group activation or the subsequent conditional handover associated with the subsequent conditional primary cell change or addition. However, the UE may not be configured to optimize subsequent secondary cell group activation configurations or subsequent conditional handover configurations in accordance with the single reference configuration or the multiple reference configurations. This may result, for example, in ping-ponging between network nodes due to the other configurations not being optimized. In some cases, the UE may identify a radio link failure, a handover failure, a secondary cell group radio link failure, or a primary secondary cell change failure. The radio link failure or the handover failure may be associated with a subsequent conditional handover configuration formulation error during a subsequent conditional handover, and the primary secondary cell change failure may be associated with a selective secondary cell group activation configuration formulation error during a conditional primary secondary cell change. However, the UE may not be configured to signal a subsequent conditional handover failure indicator that indicates the radio link failure or the handover failure, or to signal a selective secondary cell group activation failure indicator that indicates the secondary cell group radio link failure or the primary secondary cell change failure. This may result in poor communications or failed communications between the UE and the network node. In some cases, the UE may obtain an indication to perform a conditional handover in accordance with a conditional handover configuration with a plurality of conditional primary secondary cell change configurations or a plurality of conditional primary secondary cell addition configurations. However, the UE may not be configured to optimize other configurations (e.g., subsequent conditional handover configurations) in accordance with the conditional handover configuration associated with the plurality of conditional primary secondary cell change configurations or the plurality of conditional primary secondary cell addition configurations. This may result, for example, in ping-ponging between network nodes due to the other configurations not being optimized. In some cases, the UE may identify an error during a conditional handover execution with a plurality of conditional primary secondary cell changes or a plurality of conditional primary secondary cell additions. However, the UE may not be configured to transmit information associated with the error(s) to a network node, such as whether the conditional handover was performed too early, whether the conditional handover was performed too late, or whether the conditional primary cell change or conditional primary cell addition was performed incorrectly. This may result in poor communications or failed communications between the UE and the network node.

Various aspects generally relate to wireless communications. Some aspects more specifically relate to conditional handover and selective secondary cell group activation. In some aspects, a UE may obtain an indication to perform a selective secondary cell group activation or a subsequent conditional handover associated with a subsequent conditional primary cell change. The UE may initiate the selective secondary cell group activation or the subsequent conditional handover, and may detect a failure occurrence associated with the selective secondary cell group activation or the subsequent conditional handover. The UE may transmit, in accordance with detecting the failure occurrence associated with the selective secondary cell group activation or the subsequent conditional handover, information associated with the selective secondary cell group activation or the subsequent conditional handover. In some aspects, the UE may identify a radio link failure, a handover failure, a secondary cell group radio link failure, or a primary secondary cell change failure, where the radio link failure or the handover failure is associated with a subsequent conditional handover configuration formulation error during a subsequent conditional handover, and the primary secondary cell change failure is associated with a selective secondary cell group activation configuration formulation error during a conditional primary secondary cell change. The UE may transmit a subsequent conditional handover failure indicator that indicates the radio link failure or the handover failure, or may transmit a selective secondary cell group activation failure indicator that indicates the secondary cell group radio link failure or the primary secondary cell change failure. In some aspects, the UE may obtain an indication to perform a conditional handover in accordance with a conditional handover configuration with a plurality of conditional primary secondary cell change configurations or a plurality of conditional primary secondary cell addition configurations. The UE may initiate the conditional handover and at least one of a conditional primary secondary cell change or a plurality of conditional primary secondary cell addition associated with the plurality of conditional primary secondary cell addition configurations, and may detect a failure occurrence associated with the conditional handover, or at least one of the conditional primary secondary cell change or the conditional primary secondary cell addition. The UE may transmit, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations. In some aspects, the UE may identify an error during a conditional handover execution with a plurality of conditional primary secondary cell changes or a plurality of conditional primary secondary cell additions. The UE may transmit information that indicates the error during the conditional handover execution with the plurality of conditional primary secondary cell changes or the plurality of conditional primary secondary cell additions. The information may indicate, for example, whether the conditional handover was performed too early, whether the conditional handover was performed too late, or whether the conditional primary cell change or conditional primary cell addition was performed incorrectly, among other examples.

Particular aspects of the subject matter described in this disclosure can be implemented to realize one or more of the following potential advantages. In some examples, by transmitting the information associated with the selective secondary cell group activation or the subsequent conditional handover, the described techniques can be used to optimize subsequent selective secondary cell group activation configurations and/or subsequent conditional handover configurations, which may improve communications between the UE and the network node and may reduce ping-ponging between network nodes. In some examples, by transmitting the subsequent conditional handover failure indicator that indicates the radio link failure or the handover failure, or transmitting the selective secondary cell group activation failure indicator that indicates the secondary cell group radio link failure or the primary secondary cell change failure, the described techniques can be used to reduce a likelihood of failed communications between the UE and the network node. In some examples, by transmitting the information associated with the conditional handover configuration associated with the plurality of conditional primary secondary cell change configurations or the plurality of conditional primary secondary cell addition configurations, the described techniques can be used to optimize subsequent conditional handover configurations, which may improve communications between the UE and the network node and may reduce ping-ponging between network nodes. In some examples, by transmitting the information that indicates the error during the conditional handover execution with the plurality of conditional primary secondary cell changes or the plurality of conditional primary secondary cell additions, the described techniques can be used to reduce a likelihood of failed communications between the UE and the network node. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

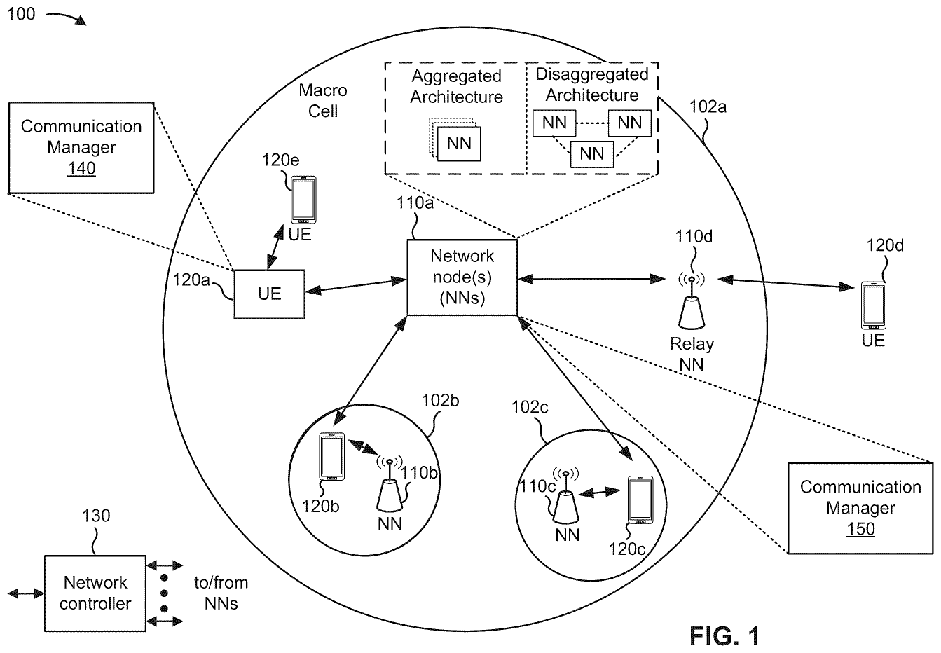

FIG. 1 is a diagram illustrating an example of a wireless network 100, in accordance with the present disclosure. The wireless network 100 may be or May include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. In some aspects, as described in more detail elsewhere herein, the communication manager 140 may obtain an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change; initiate the selective secondary cell group activation or the subsequent conditional handover; detect a failure occurrence associated with the selective secondary cell group activation or the subsequent conditional handover; and transmit, in accordance with detecting the failure occurrence associated with the selective secondary cell group activation or the subsequent conditional handover, information associated with the selective secondary cell group activation or the subsequent conditional handover. In some other aspects, as described in more detail elsewhere herein, the communication manager 140 may obtain an indication to perform a conditional handover in accordance with a conditional handover configuration with a plurality of conditional primary secondary cell change configurations or a plurality of conditional primary secondary cell addition configurations; initiate the conditional handover and at least one of a conditional primary secondary cell change associated with the plurality of conditional primary secondary cell change configurations or a conditional primary secondary cell addition associated with the plurality of conditional primary secondary cell addition configurations; detect a failure occurrence associated with the conditional handover, or and at least one of the conditional primary secondary cell change or the conditional primary secondary cell addition; and transmit, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations. In some aspects, as described in more detail elsewhere herein, the communication manager 140 may identify an error during a conditional handover execution with a plurality of conditional primary secondary cell change or a plurality of conditional primary secondary cell addition; and transmit information that indicates the error during the conditional handover execution with the plurality of conditional primary secondary cell changes or the plurality of conditional primary secondary cell additions. Additionally, or alternatively, the communication manager 140 may perform one or more other operations described herein.

In some aspects, the network node 110 may include a communication manager 150. As described in more detail elsewhere herein, the communication manager 150 may identify a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and transmit a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error. Additionally, or alternatively, the communication manager 150 may perform one or more other operations described herein.

As indicated above, FIG. 1 is provided as an example. Other examples may differ from what is described with regard to FIG. 1.

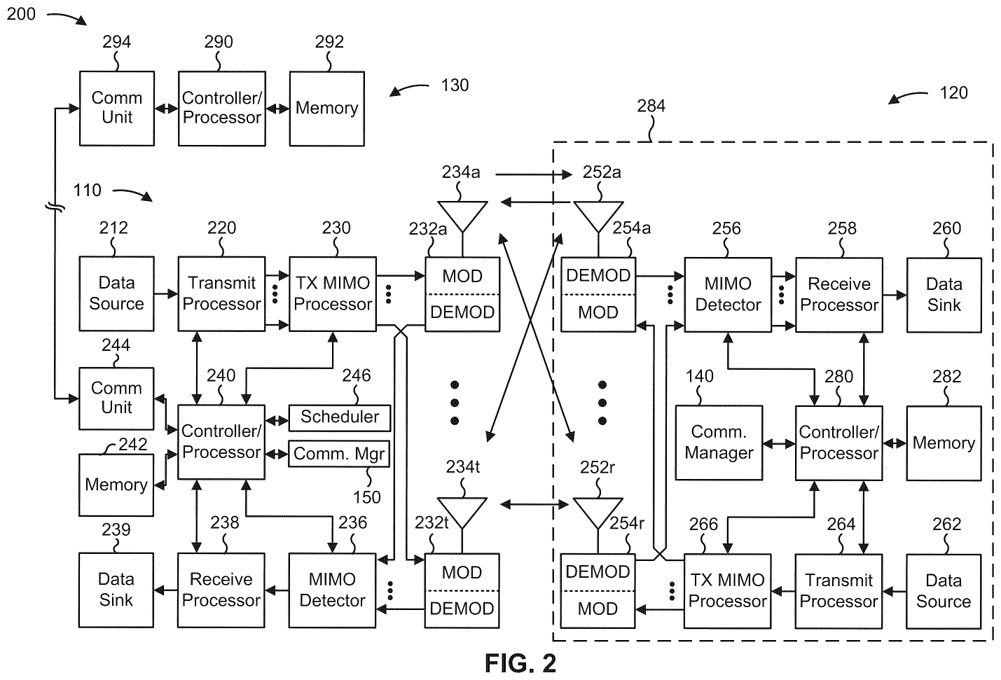

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

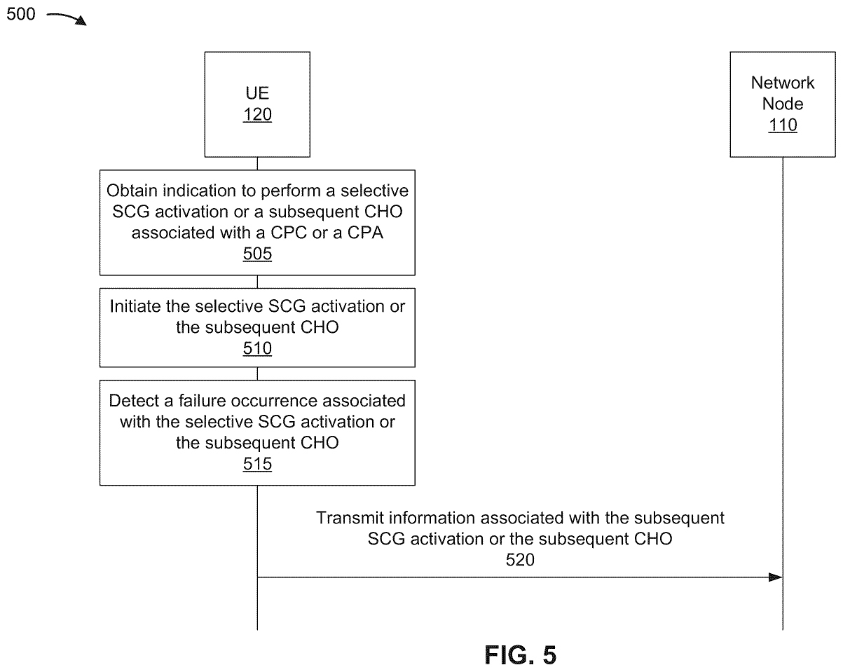

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-15).

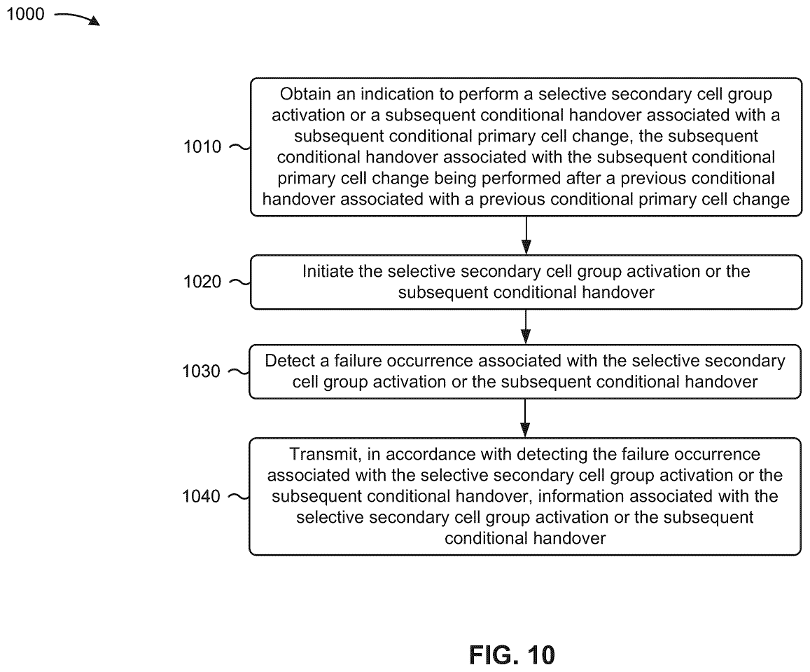

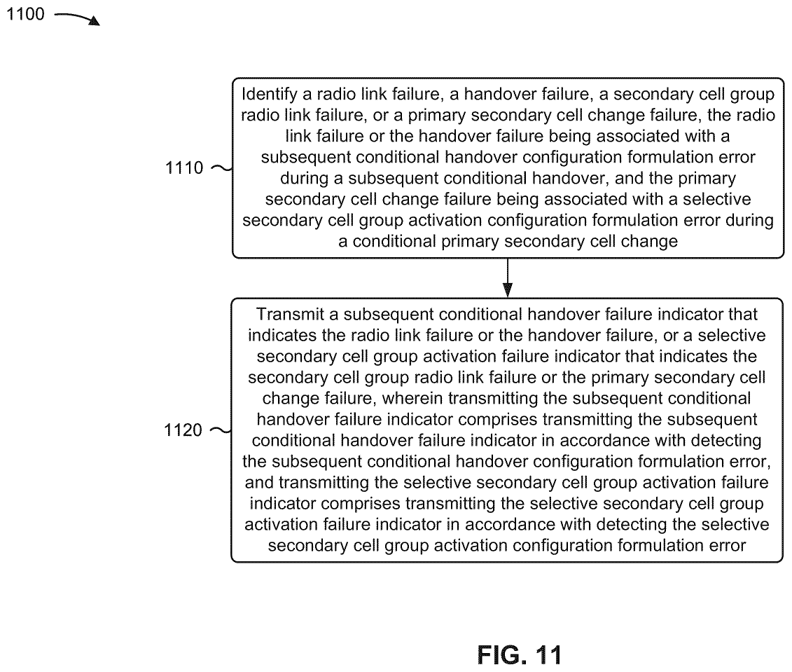

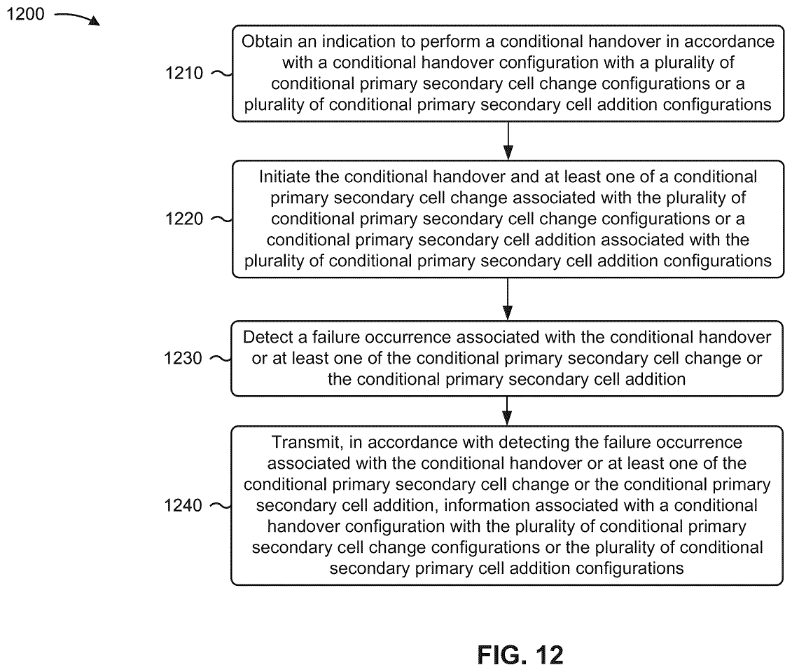

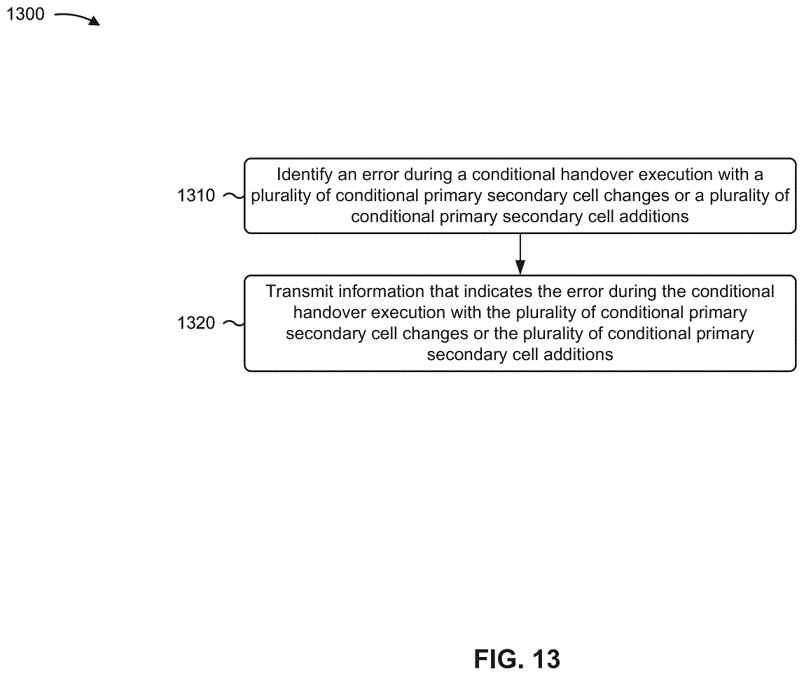

The controller/processor 240 of the network node 110, the controller/processor 280 of the UE 120, and/or any other component(s) of FIG. 2 may perform one or more techniques associated with conditional handover and selective secondary cell group activation, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for obtaining an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change; means for initiating the selective secondary cell group activation or the subsequent conditional handover; means for detecting a failure occurrence associated with the selective secondary cell group activation or the subsequent conditional handover; and/or means for transmitting, in accordance with detecting the failure occurrence associated with the selective secondary cell group activation or the subsequent conditional handover, information associated with the selective secondary cell group activation or the subsequent conditional handover. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for identifying a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and/or means for transmitting a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for obtaining an indication to perform a conditional handover in accordance with a conditional handover configuration with a plurality of conditional primary secondary cell change configurations or a plurality of conditional primary secondary cell addition configurations; means for initiating the conditional handover and at least one of a conditional primary secondary cell change associated with the plurality of conditional primary secondary cell change configurations or a conditional primary secondary cell addition associated with the plurality of conditional primary secondary cell addition configurations; means for detecting a failure occurrence associated with the conditional handover, or at least one of the conditional primary secondary cell change or the conditional primary secondary cell addition; and/or means for transmitting, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for identifying an error during a conditional handover execution with a plurality of conditional primary secondary cell change or a plurality of conditional primary secondary cell addition; and/or means for transmitting information that indicates the error during the conditional handover execution with the plurality of conditional primary secondary cell changes or the plurality of conditional primary secondary cell additions. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

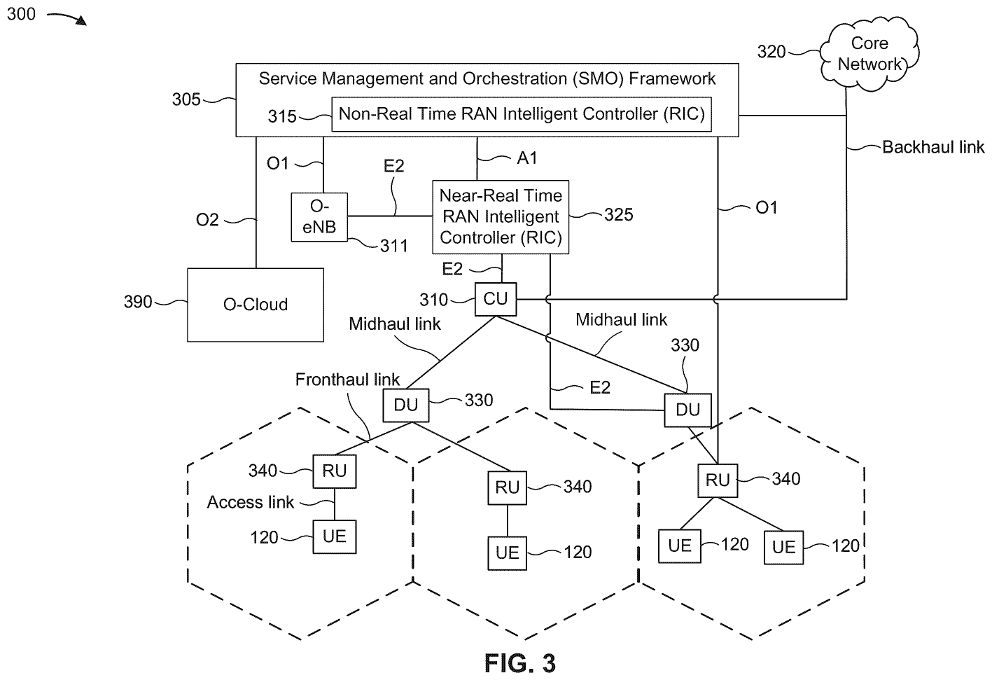

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

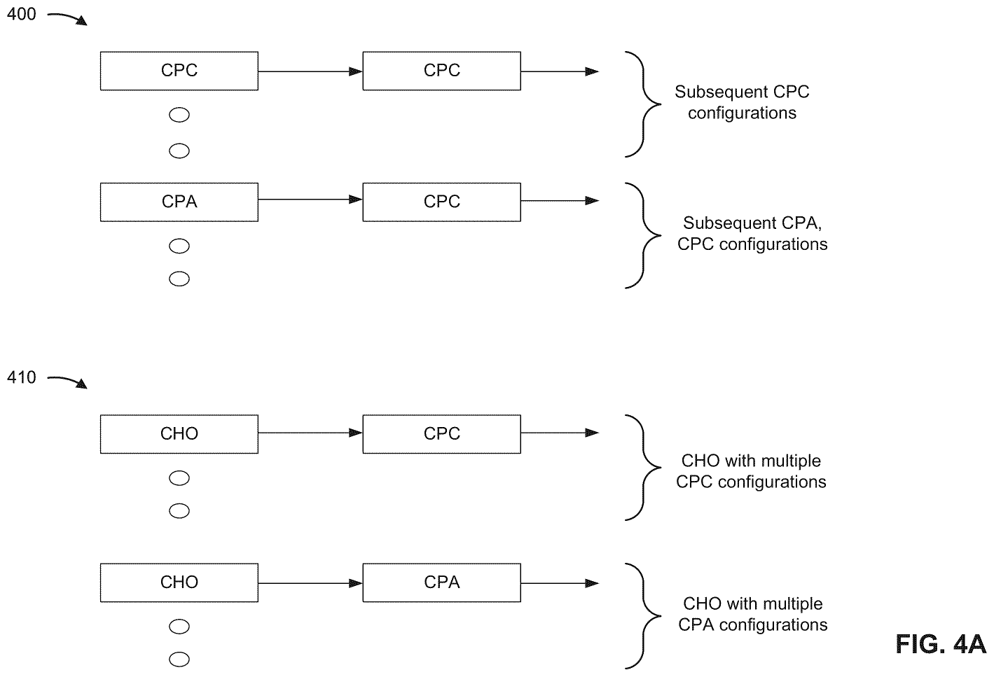

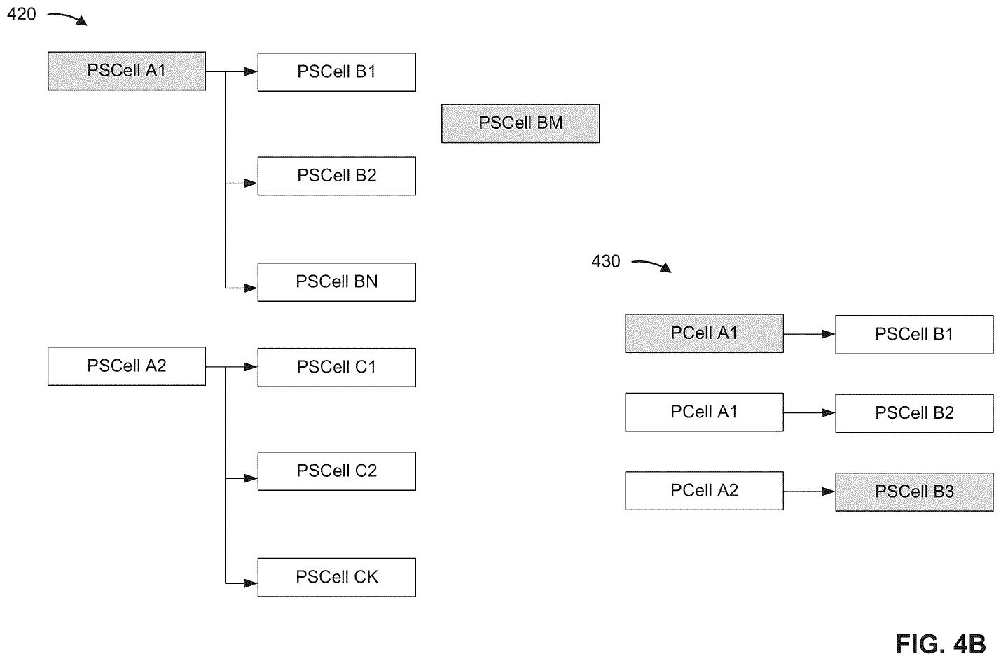

FIGS. 4A-4B are diagrams illustrating examples of conditional handovers, in accordance with the present disclosure.

As shown in example 400, in FIG. 4A, a UE may perform selective secondary cell group (SCG) activation. For example, the UE may perform a conditional primary cell (PCell) change (CPC) in accordance with one or more CPC configurations. Additionally, or alternatively, the UE may perform a conditional PCell addition (CPA) and a CPC in accordance with one or more CPA and CPC configurations.

In some cases, the selective SCG activation may be performed in accordance with a secondary node (SN)-initiated intra-SN procedure. In some other cases, the SCG activation may be performed in accordance with a master node (MN)-initiated inter-SN procedure. This may apply to all subsequent CPCs. In this case, a candidate SN may generate a CPC for a subsequent CPC. In some other cases, the SCG activation may be performed in accordance with an SN-initiated inter-SN procedure. In this case, a candidate SN may generate a subsequent CPC configuration. In some cases, the UE may store a reference configuration as a separate configuration. For inter-SN CPC, the MN may provide the reference configuration to all candidate SNs (e.g., in order to generate the T-SN candidate configuration). When the execution condition for a CPC candidate primary secondary cell (PSCell) is met, the UE may execute the CPC toward that candidate PSCell. In some cases, after completing a PSCell addition or change, the UE may not release the conditional configuration of other candidate PSCells for subsequent CPCs. The UE may continue to evaluate the execution conditions of other candidate PSCells.

As shown in example 410, the UE may perform a conditional handover (CHO) with multiple CPA and CPC configurations. For example, the UE may perform a CHO in accordance with one or more CPC configurations. Additionally, or alternatively, the UE may perform a CHO in accordance with one or more CPA configurations.

In some cases, the UE may be configured with a master cell group (MCG) configuration and an SCG configuration. If multiple candidate PSCells are indicated for the same PCell, the network may provide one or more CHO configurations. In some cases, the UE may not execute CPC or CPA unless a CHO condition is satisfied (e.g., regardless of whether parallel or sequential evaluation is performed). When both CHO and CPC conditions are met, both CHO and CPC cell changes may be executed. In some cases, the UE may wait until both CHO and CPC conditions are satisfied. The network may provide CHO-only configuration to avoid failures (if needed). Alternatively, when a CHO condition is met, but a CPC condition is not met, CHO execution may be triggered and the source SCG can be released. If allowed in the new configuration, the UE may continue evaluation of the CPC and CPA conditions. For CHO execution conditions, the source MN may determine the execution conditions for the candidate PCells based at least in part on a source MCG measurement configuration (MeasConfig). For CPA/CPC execution conditions, the candidate MN may determine the parameters of the execution conditions for candidate PSCells. The candidate MN may inform the source MN regarding the prepared candidate PSCells and parameters of the associated execution conditions. According to the received information from the candidate MN, the source MN generates the corresponding execution conditions based on the source MCG measurement configuration to the UE.

As shown in example 420, in FIG. 4B, the UE may perform selective SCG activation. The UE may perform the selective SCG activation, for example, to optimize subsequent CPA and CPC configurations and/or to reduce a ping-pong effect between PSCells. In one example, the UE may be connected to PSCell A0 and may receive the configuration shown in FIG. 4B. For example, the UE may receive a configuration for PSCell A1 that indicates PSCell B1, PSCell B2, and PSCell B2, a configuration for PSCell A2 that indicates PSCell C1, PSCell C2, and PSCell CK, and a configuration for PSCell BM. In some cases, configurations for MN and SN (including reference and/or delta configurations) may be optimized. In one example, PSCell A1 may be selected for CPC or CPA but fail. For example, a measurement may show that either PSCell A0 or PSCell A2 is the better cell than A1. In another example, after PSCell A1, no configured cell may be selected as the target cell and an SCG failure may occur. For example, a measurement may show that another cell (e.g., PSCell BM) is the best cell. Alternatively, a PSCell BK may be selected at A1 but fail. For example, a measurement may show that either PSCell A1 or PSCell BN is the best cell.

As shown in example 430, the UE may perform a CHO with multiple CPCs or CPAs. The UE may optimize the CHO with multiple CPC or CPA configurations, and appropriate PSCells may be selected for a PCell. As shown in FIG. 4B, the UE May receive a first configuration for PCell A1 that indicates PSCell B1, a second configuration for PCell A1 that indicates PSCell B2, and a configuration for PCell A2 that indicates PSCell B3. In this example, PSCell B3 should have been configured by the network as the PSCell of PSCell A1. Alternatively, the UE should have been configured with a CHO-only or CHO with an SCG configuration. For example, if the UE is provided with CHO and CPC configurations, radio link failure may occur.

As indicated above, FIG. 4 is provided as an example. Other examples may differ from what is described with regard to FIG. 4.

FIG. 5 is a diagram illustrating an example 500 of selective secondary cell group activation and subsequent conditional handover configurations, in accordance with the present disclosure.

As shown by reference number 505, the UE 120 may obtain an indication to perform a selective SCG activation or a subsequent CHO associated with a subsequent CPC.

In a first example, the UE 120 may obtain (e.g., receive) a single reference configuration that corresponds to a selective SCG activation configuration or a CHO configuration associated with the CPC or the CPA. In a second example, the UE 120 may obtain (e.g., receive) a plurality of reference configurations that correspond to a plurality of respective selective SCG activation configurations or a plurality of respective CHO configurations associated with the CPC or the CPA.

As shown by reference number 510, the UE 120 may initiate the selective SCG activation or the subsequent CHO. The UE 120 may initiate the selective SCG activation or the subsequent CHO in accordance with the single reference configuration and/or in accordance with the multiple reference configurations.

As shown by reference number 515, the UE 120 may detect a failure occurrence associated with the selective SCG activation or the subsequent CHO. For example, the UE 120 may detect that one or more SCGs were not activated and/or may detect that a handover associated with the subsequent CHO configuration was not successful.

As shown by reference number 520, the UE 120 may transmit, and the network node 110 may receive, information associated with the selective SCG activation or the subsequent CHO. In some aspects, the UE 120 may transmit a self-organizing network (SON) report that includes the information associated with the selective SCG activation or the subsequent CHO.

In the first example, transmitting the information associated with the selective SCG activation or the subsequent CHO may include transmitting cell identity information. For example, for a subsequent CPA/CPC configuration, and in accordance with an SCG failure, the UE 120 may transmit an indication of a previous PSCell identifier (ID), such as a PSCell ID of a PSCell on which a last PSCell change was performed for a subsequent CPC. Additionally, or alternatively, for a subsequent CHO configuration, and in accordance with a radio link failure (RLF), the UE 120 may transmit an indication of a previous PCell ID, such as a PCell ID of a PCell on which a last PCell change was performed for a subsequent CHO. In some examples, transmitting the information transmitting the information associated with the selective SCG activation or the subsequent CHO may include transmitting timing information. For example, the UE 120 may transmit an indication of a timer (e.g., a dedicated timer) that indicates a time elapsed since a last CHO, CPC, or CPA execution until an MCG or SCG failure. Additionally, or alternatively, the UE 120 may transmit an indication of a time gap between a last configuration and a delta configuration (per target PCell/PSCell). Additionally, or alternatively, the UE 120 may transmit an indication of a time gap between a delta configuration and a failure (per target PCell/PSCell). In some examples, transmitting the information associated with the selective SCG activation or the subsequent CHO may include transmitting an indication of whether the UE 120 failed to comply with a provided delta configuration. In some examples, transmitting the information associated with the selective SCG activation or the subsequent CHO may include transmitting measurement information. For example, the UE 120 may store one or more measurements obtained before each CHO, CPA, or CPC execution during a subsequent CHO, CPA, or CPC. The UE 120, in accordance with an MCG or SCG failure, or in accordance with a CHO, CPA, or CPC failure, the UE 120 may report the stored measurements (e.g., the latest measurements obtained immediately before each subsequent CHO/CPA/CPC execution).

In the second example, transmitting the information associated with the selective SCG activation or the subsequent CHO may include transmitting the cell identity information, the timing information, the measurement information, and/or the indication of whether the UE 120 failed to comply with the provided delta configuration. Additionally, or alternatively, transmitting the information associated with the selective SCG activation or the subsequent CHO may include transmitting other timing information that indicates a time gap between a last configuration and a reference configuration update (per target PSCell) and/or a time gap between a reference configuration update and a failure (per target PSCell). Additionally, or alternatively, transmitting the information associated with the selective SCG activation or the subsequent CHO may include transmitting an indication of whether the UE 120 failed to comply with the updated reference configuration.

In some aspects, the UE 120 may transmit, and the network node 110 may receive, mobility history information (MHI) that includes a flag that indicates whether a subsequent CHO is used for a handover and/or whether a subsequent CPA/CPC was used for PSCell changes or additions. Additionally, or alternatively, the network node 110 may transmit, and the UE 120 may receive, MHI that includes a flag that indicates whether a subsequent CHO is used for a handover and/or whether a subsequent CPA/CPC was used for PSCell changes or additions. This may reduce or eliminate unnecessary ping-ponging resulting from inappropriate configurations.

As indicated above, FIG. 5 is provided as an example. Other examples may differ from what is described with regard to FIG. 5.

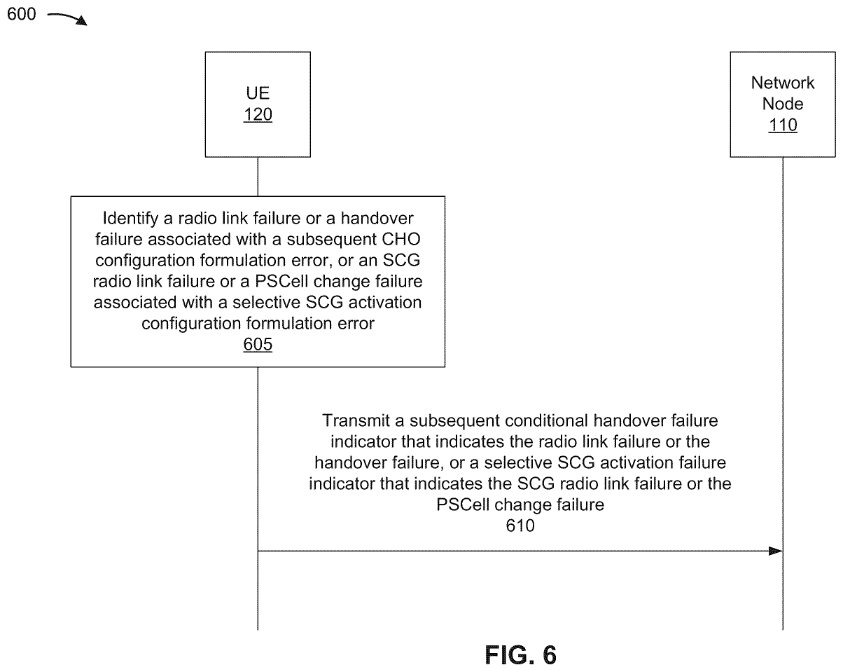

FIG. 6 is a diagram illustrating an example 600 of subsequent conditional handover failure and selective secondary cell group activation failure indication, in accordance with the present disclosure.

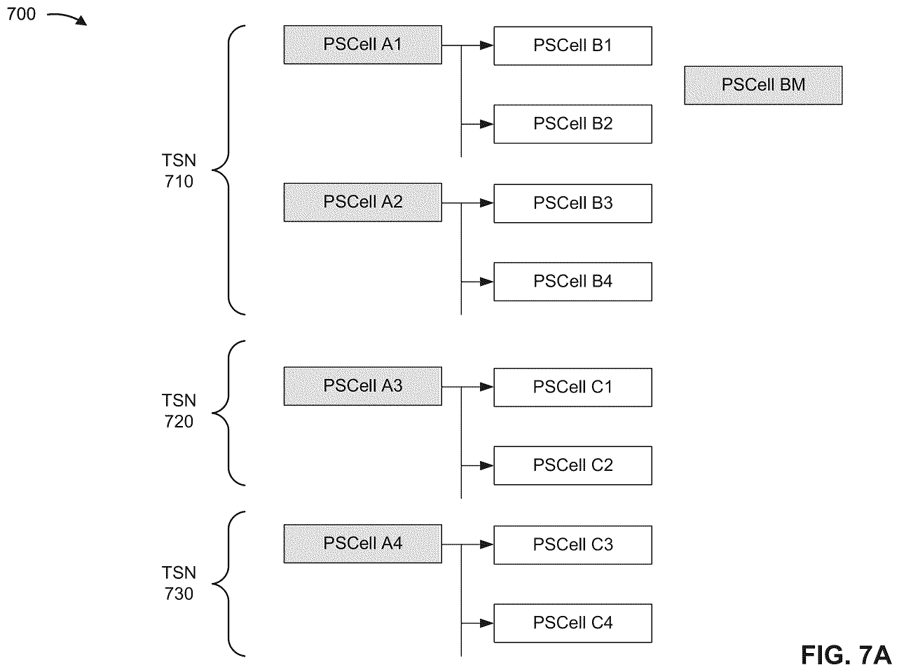

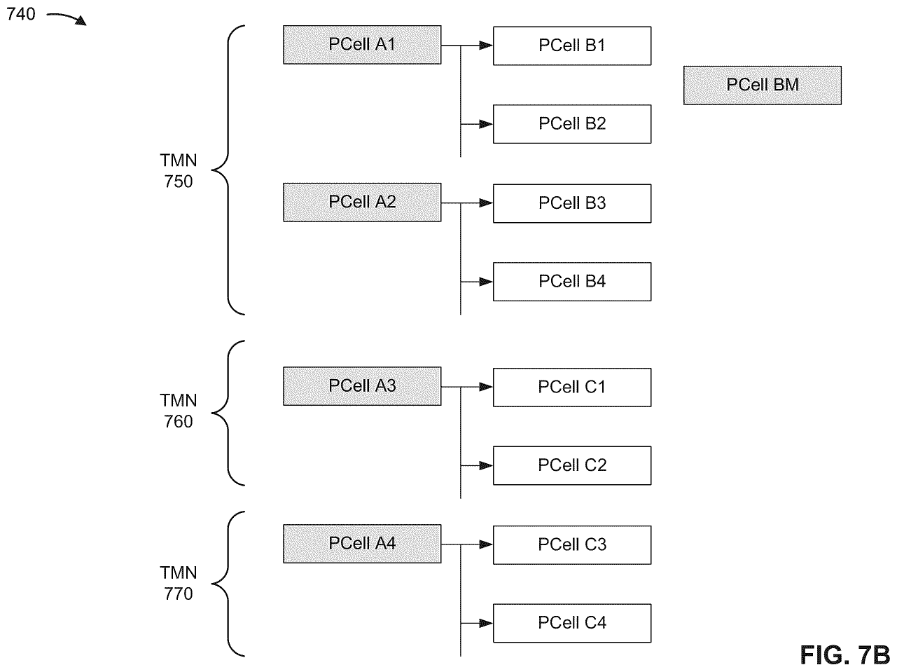

As shown by reference number 605, the UE 120 may identify an RLF, a handover failure, an SCG RLF, or a PSCell change failure. The UE 120 may identify the RLF or the handover failure based at least in part on a subsequent CHO configuration formulation error during a subsequent CHO. Alternatively, the UE 120 may identify the PSCell change failure based at least in part on a selective SCG activation configuration formulation error during a conditional PSCell change. Additional details regarding these features are described in connection with FIGS. 7A-7B.

As shown by reference number 610, the UE 120 may transmit, and the network node 110 may receive, a subsequent CHO failure indicator that indicates the radio link failure or the handover failure, and/or may transmit a selective SCG activation failure indicator that indicates the SCG RLF or the PSCell change failure.

The UE 120 may transmit the subsequent CHO failure indicator based at least in part on detecting the subsequent CHO configuration formulation error. In some aspects, for MN-initiated inter-SN CPC, root cause analysis may be performed at the MN, for example, if a subsequent CPA/CPC configuration (which includes candidate cell list and execution conditions) is generated by the MN. Alternatively, root cause analysis may be performed at the MN and one or more candidate SNs, for example, if a subsequent CPA/CPC configuration is generated by a candidate SN. In this example, the report may be transmitted to the MN and all candidate SNs (e.g., to determine if the candidate SN was selected by the MN appropriately, and if the PSCells selected by the candidate SN for subsequent CPA/CPC are appropriate). In some aspects, root cause analysis may be performed at the source SN and one or more candidate SNs. In this example, the report may be transmitted to the source SN and all candidate SNs. In some aspects, for SN-initiated intra-SN CPC (e.g., without MN involvement), root cause analysis may be performed at the SN, and all candidate PSCells may belong to the same SN.

The UE 120 may transmit the selective SCG activation failure indicator based at least in part on detecting the selective SCG activation configuration formulation error. In some aspects, root cause analysis may be performed at the source MN, for example, if a subsequent CHO configuration (which includes candidate cell list and execution conditions) is generated by the source MN. Alternatively, root cause analysis may be performed at the MN and candidate MNs if a subsequent CHO configuration is generated by the candidate MNs. In this example, the report may be transmitted to the source MN and all candidate MNs (e.g., to determine if the candidate MN was selected by the source MN appropriately and/or if the PCells selected by the candidate MN for subsequent CHO are appropriate). Additional details regarding these features are described in connection with FIGS. 7A-7B.

As indicated above, FIG. 6 is provided as an example. Other examples may differ from what is described with regard to FIG. 6.

FIGS. 7A-7B are diagrams illustrating examples of selective secondary cell group configurations and conditional handover configurations, in accordance with the present disclosure.

As shown in FIG. 7A and example 700, a target secondary node (TSN) 710 may include PSCell A1, PSCell A2, and PSCell BM. PSCell A1 may include PSCell B1 and PSCell B2. PSCell A2 may include PSCell B3 and PSCell B4. TSN 720 may include PSCell A3. PSCell A3 may include PSCell C1 and PSCell P2. TSN 730 may include PSCell A4. PSCell A4 may include PSCell C3 and PSCell P4. The UE 120 may transmit a new PSCell change type to identify that a PSCell change failed due to incorrect formulation of candidates during a subsequent CPC. In some cases, after a last CPC/CPA execution, an SCG failure may occur as the execution condition for the subsequent CPA/CPC may not satisfy one or more conditions. For example, one or more measurements may indicate that an appropriate cell was not configured for subsequent CPA/CPC. In one example, a measurement report may show that PSCell B3 (not configured for subsequent CPA/CPC for PSCell A1), PSCell BM (not configured for the subsequent CPA/CPC), PSCell C1 (prepared by another candidate SN) is a suitable PSCell. As described above in connection with FIG. 6, in some aspects, a root cause analysis may be performed at the MN and one or more candidate SNs, for example, if a subsequent CPA/CPC configuration is generated by a candidate SN. In this example, the report may be transmitted to the MN and to all of the candidate SNs (e.g., to determine if the candidate SN was selected by the MN appropriately, and if the PSCells selected by the candidate SN for subsequent CPA/CPC are appropriate). For example, the MN may determine that TSN 730 is not a good candidate cell, but that TSN 720 is a good candidate cell. TSN 720 may determine whether PSCell A3 or PSCell A5 execution conditions are capable of being modified.

As shown in FIG. 7B and example 740, a target master node (TMN) 750 may include PCell A1, PCell A2, and PCell BM. PCell A1 may include PCell B1 and PCell B2. PCell A2 may include PCell B3 and PCell B4. TMN 760 may include PCell A3. PCell A3 may include PCell C1 and PCell P2. TMN 770 may include PCell A4. PCell A4 may include PCell C3 and PCell P4. The UE 120 may transmit a PCell change type to identify that a PCell change failed due to an incorrect formulation of candidates during a subsequent CHO. In some cases, after a last CHO execution, RLF may occur as the execution condition for subsequent CHO is not satisfied. For example, one or more measurements may indicate that an appropriate cell was not configured for the subsequent CHO. In one example, a measurement report may indicate that PCell B3 (not configured for subsequent CHO for PCell A1), PCell BM (not configured for the subsequent CHO), or PCell C1 (prepared by another candidate SN) is a suitable PCell. As described above in connection with FIG. 6, root cause analysis may be performed at the MN and candidate MNs if a subsequent CHO configuration is generated by the candidate MNs. In this example, the report may be transmitted to the source MN and all candidate MNs (e.g., to determine if the candidate MN was selected by the source MN appropriately and/or if the PCells selected by the candidate MN for subsequent CHO are appropriate). For example, the source MN may determine that candidate TMN 760 is not a good candidate cell but that TMN 770 is a good candidate cell. Candidate TMN 770 may determine whether PCell A3 or PCell A5 execution conditions are capable of being modified.

As indicated above, FIGS. 7A-7B are provided as examples. Other examples may differ from what is described with regard to FIGS. 7A-7B.

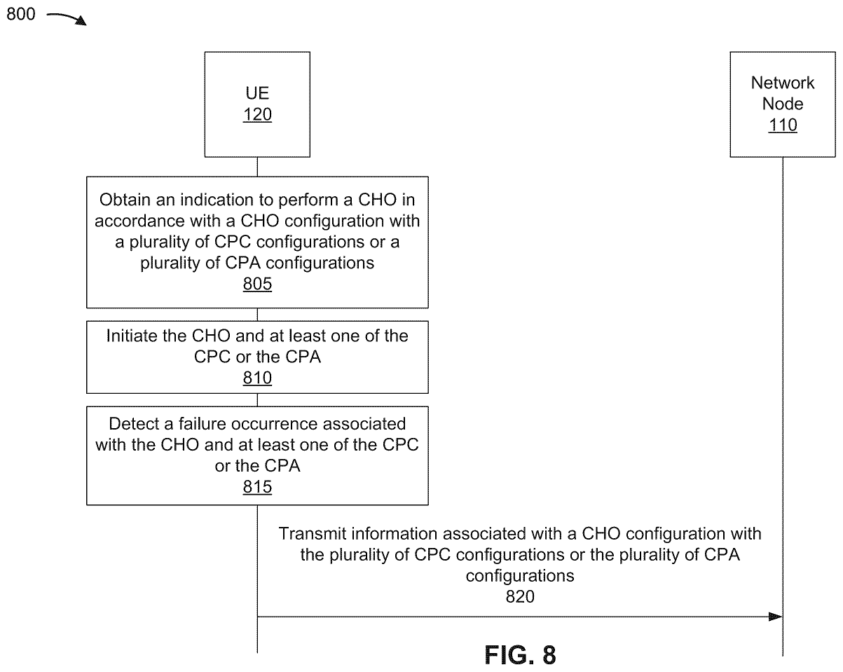

FIG. 8 is a diagram illustrating an example 800 of conditional handover signaling, in accordance with the present disclosure.

As shown by reference number 805, the UE 120 may obtain an indication to perform a CHO with CPA/CPC in accordance with a CHO configuration and a plurality of CPC configurations or a plurality of CPA configurations. In a first example, the CHO and CPA/CPC are not be performed, and RLF is observed at the UE. In this example, CHO execution conditions (for a PCell, e.g., PCell A1) may be satisfied but execution conditions for a configured conditional PSCell (e.g., a nested PSCell of PCell A1) change or addition may not be satisfied. In another example, CPA/CPC execution conditions (for a PSCell, e.g., PSCell B3) may be satisfied but execution conditions for conditional handover may not be satisfied. In another example, both CHO and CPC/CPA execution conditions may be satisfied (both for CHO and CPA/CPC), but either the CHO fails or the RLF happens after a successful CHO execution. In another example upon CHO with CPC/CPA execution (e.g., both CHO and CPA/CPC conditions may be satisfied), but either CPA/CPC execution fails or SCG fails after a successful CPA/CPC. In another example upon CHO with CPC/CPA execution (e.g., both CHO and CPA/CPC conditions may be satisfied), but both CHO and CPA/CPC fails or both MCG and SCG RLFs after successful CHO and CPA/CPC.

As shown by reference number 810, the UE 120 may initiate the CHO and at least one of the CPA or the CPC. For example, the UE 120 may initiate the CHO and the CPA, or the CHO and the CPC, based on the configuration provided.

As shown by reference number 815, the UE 120 may detect a failure occurrence associated with the CHO or at least one of the CPA or the CPC. For example, the UE 120 may detect a failure occurrence associated with a CHO or a CPA, a failure occurrence associated with a CHO or a CPC.

As shown by reference number 820, the UE 120 may transmit, and the network node 110 may receive, information associated with a CHO configuration with the plurality of CPC configurations or the plurality of CPA.

In the first example, transmitting the information associated with the CHO configuration may include transmitting, for each configured conditional configuration, a configured PCell ID and a configured PSCell ID. The configured PCell ID may indicate if the execution condition for the PCell ID has been satisfied. If yes, the UE 120 may indicate the first event and the time gap between the two events. If no, the UE 120 may indicate that an event condition has been satisfied. Additionally, the configured PCell ID may indicate one or more CHO execution conditions. The configured PSCell ID may indicate if the execution condition for the PSCell ID has been satisfied. If yes, the UE 120 may indicate the first event and the time gap between the two events. If no, the UE 120 may indicate that an event condition has been satisfied. Additionally, the UE 120 may indicate one or more CPC/CPA execution conditions. In some aspects, transmitting the information associated with the CHO configuration may include transmitting timing information. The timing information may indicate a time gap between a time that a CHO, CPA, or CPC trigger condition has been satisfied and an RLF. Additionally, or alternatively, the timing information may indicate a time gap between meeting events associated with the CHO and the CPA/CPC execution conditions. In some aspects, transmitting the information associated with the CHO configuration may include transmitting measurement information, such as measurement information that includes PCell and PSCell related measurements. In some aspects, transmitting the information associated with the CHO configuration may include transmitting an indication of whether legacy CHO-only is configured or whether legacy CHO with SCG is configured. Alternatively, the UE 120 may indicate that CHO recovery is not performed because CHO-only is not configured. Alternatively, the UE 120 may indicate a new RLF cause as {CHO+CPC/CPA Config.}, since the handover may not be able to be performed if both CHO and CPC/CPA conditions were not satisfied (and if CHO-only or CHO with SCG is not configured). In some aspects, transmitting the information associated with the CHO configuration may include transmitting an indication of whether SCG failure was detected during a CHO with CPC configuration evaluation. In some aspects, transmitting the information associated with the CHO configuration may include transmitting an indication of whether the UE can (or cannot) comply with the provided PCell or PSCell configuration after CHO with CPC evaluation.

In the second example, transmitting the information associated with the CHO configuration may include transmitting SCG failure information (SCGFailureInformation). For example, the UE 120 may transmit SCG failure information that indicates that a last PSCell change occurred along with a CHO (e.g., a new PSCell change type, such as CHO with CPC).

In the third example, if the CHO-only or the CHO with SCG configuration is provided, the network node 110 may not be able to determine a quality of the CHO with CPC/CPA configuration. In this case, transmitting the information associated with the CHO configuration may include transmitting trigger information associated with the CHO. This may enable the network node 110 to determine, for example, how to correlate successful handover report (SHR) and successful primary cell change report (SPR) generating during CHO with CPC/CPA configurations (such as how to determine whether the SHR, SPR, SCG failure information, and/or an RLF report are generated as a result of the same CHO with CPC/CPA configurations). In some aspects, transmitting the trigger information associated with the CHO may include transmitting a trigger that indicates to generate an SHR if a CHO-only or CHO with SCG configuration is used for performing a handover. For example, a first trigger may indicate to generate a first SHR if a CHO-only configuration is used for performing the handover, and a second trigger may indicate to generate a second SHR if a CHO with SCG configuration is used for performing the handover. In some aspects, the SHR may indicate that the SHR includes CHO-only or CHO with SCG, may include both PCell and PSCell measurements, may indicate an occurrence of an SCG failure, and/or may indicate SCG failure information in accordance with an SCG failure being observed.

In one example, an SHR and SPR correlation may be based at least in part on a configuration index. In another example, an SHR and SPR correlation may be indicated in the SHR and/or in the SPR. For example, the SHR may indicate whether an SPR is generated, and/or the SPR may indicate whether an SHR is generated. A C-RNTI of the source and target PSCells may be included in the SHR. Additionally, or alternatively, a C-RNTI of the source and target PCells may be included in the SPR. In another example, the SHR and SPR correlation may be based at least in part on whether the SHR and/or the SPR are generated for a CHO with CPA/CPC configuration. In this example, an SPR may be included within a container inside of the SHR. In some aspects, an RLF or SCG failure indication may indicate a correlation between the SPR or SHR. For example, an RLF report may indicate if an SPR or SCG failure information is generated belonging to the same CHO with CPC configuration. The RLF report may include the C-RNTI of the source and target PSCell. Additionally, or alternatively, the SCG failure information may indicate if an SHR or RLF report is generated belonging to the same CHO with CPC configuration. The SCG failure information may include a C-RNTI of the source and target PCell.

As indicated above, FIG. 8 is provided as an example. Other examples may differ from what is described with regard to FIG. 8.

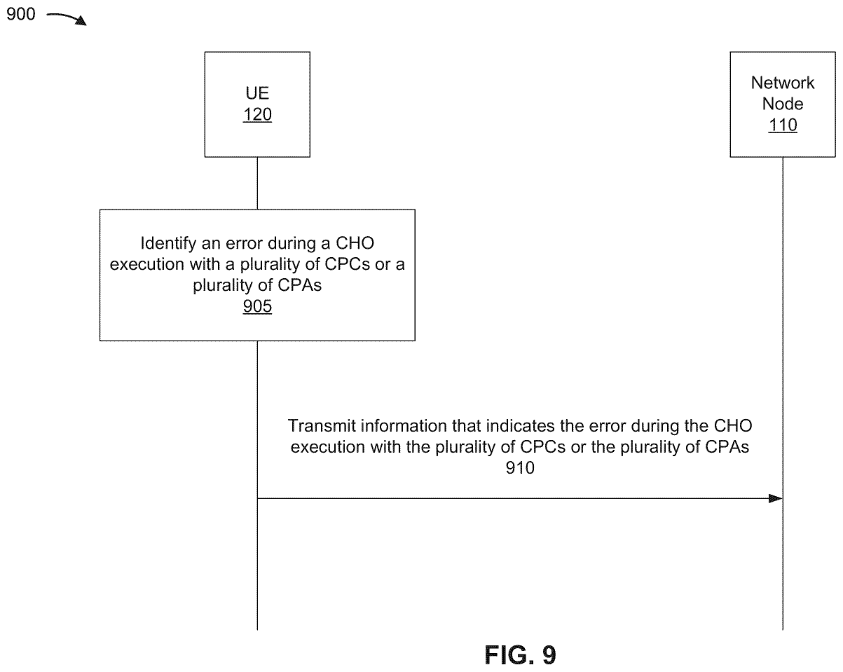

FIG. 9 is a diagram illustrating an example 900 of conditional handover signaling with multiple conditional primary cell change or conditional primary cell addition configurations, in accordance with the present disclosure.

As shown by reference number 905, the UE 120 may identify an error during a CHO execution with a plurality of CPC or a plurality of CPA.

In some aspects, the UE 120 may identify that a RLF is observed at the UE before CHO and CPA/CPC execution (e.g., the handover occurred too late). For example, the UE 120 may identify that a CHO with CPC/CPA was not executed because an execution condition for both CHO or the CPC were not satisfied. In a first example, the UE 120 may identify that the CHO execution conditions were met, but that the CPC/CPA configuration did not meet. For example, the UE 120 may identify that execution conditions for the CHO have been satisfied (or that measurement results indicate that a suitable PCell has been configured for performing CHO) but that execution conditions for the CPA/CPC are not satisfied (or that measurement results indicate that a suitable PSCell was not configured for performing CPA/CPC). In a second example, the UE 120 may identify that the CHO execution conditions were not satisfied, but that the CPA/CPC configuration were adequate. For example, the UE 120 may identify that execution conditions for the CHO are not satisfied (or that measurement results indicate that a suitable PCell was not configured for performing CHO) but that execution conditions for the CPA/CPC are satisfied (or that measurement results indicate that a suitable PSCell was not configured for performing CPA/CPC). In a third example, the UE 120 may identify that the CHO execution conditions were not met and that the CPA/CPC execution conditions were also not met. For example, the UE 120 may identify that execution conditions for the CHO are not satisfied (or that measurement results indicate that a suitable PCell was not configured for performing CHO) and that execution conditions for the CPA/CPC are not satisfied (or that measurement results indicate that a suitable PSCell was not configured for performing CPA/CPC). In some other aspects, the UE 120 may identify that CHO and CPA/CPC was executed but resulted in failures and measurement results indicates that at least previous PCell or PSCell is still suitable cell (e.g., that the CHO or CPA/CPC occurred too early). For example, the UE 120 may identify an RLF or an SCG failure after (e.g., shortly after) the successful CHO with CPC/CPA, or may identify that CHO execution fails, CPC/CPA execution fails, or both CHO and CPC/CPA execution fails. In this example, one or more measurements may indicate that a previous PCell and/or previous PSCell is still suitable. In some other aspects, the UE 120 may identify that CHO was performed incorrectly on the incorrect PCell or that a CPA/CPC was performed incorrectly on the incorrect PSCell, resulting in CHO or CPA/CPC failure. For example, the UE 120 may identify an RLF or SCG failure after (e.g., shortly after) the successful CHO with CPC/CPA, or may identify that CHO execution fails, CPC/CPA execution fails, or both CHO and CPC/CPA execution fails. In this example, one or more measurements may indicate that another PCell (e.g., other than the previous PCell and the target PCell) is suitable and/or that another PSCell (e.g., other than the previous PSCell and the target PSCell) is suitable.

As shown by reference number 910, the UE 120 may transmit, and the network node 110 may receive, information that indicates the error during the CHO associated with the plurality of CPC configurations or the plurality of CPA configurations.

In some aspects, transmitting the information that indicates the error during the CHO execution with the plurality of CPC or the plurality of CPA may include transmitting an indication that the RLF is observed at the UE before CHO and CPA/CPC execution (e.g., the handover occurred too late). In one example, if a CHO-only or CHO with SCG configuration is provided, the UE 120 may select one of the CHO-only or CHO with SCG configuration for performing a PCell handover. The UE 120 may generate an SHR that includes information associated with CHO with CPC/CPA optimization. The source MN may perform the root cause analysis first, and may transmit the report to the candidate (target) MNs for analysis. In another example, if a CHO-only or CHO with SCG configuration is not provided, an RLF may occur. The UE 120 may generate an RLF that includes information associated with CHO with CPC/CPA optimization. The source MN may perform the root cause analysis first, and may transmit the report to the candidate (target) MNs for analysis. In some aspects, transmitting the information that indicates the error during the CHO execution with the plurality of CPC or the plurality of CPA may include transmitting an indication that the CHO and CPC/CPA execution resulted in CHO or CPA/CPC failures (e.g., that the CHO and CPC/CPA execution configuration was inaccurate resulting in CHO and CPC/CPA execution while source primary cell or source primary secondary cell was still suitable cell). In one example, if CPC/CPA execution failure or SCG failure (shortly after successful CPC/CPA execution) occurs, SCG failure information is sent to the target MN indicating the failure. The received SCG failure information may be consumed locally at the target MN. Optionally, the SCG failure information may be forwarded to a previous (e.g., source) MN. In another example, if CHO execution failure or RLF (shortly after successful CHO execution) occurs, the UE 120 may generate an RLF report, and root cause analysis may be performed at the previous (e.g., source) and target MN. In another example, if both CHO and CPC/CPA execution fails, or RLF (shortly after successful CHO execution) and secondary cell group RLF (shortly after successful CPC/CPA execution) occurs, then the UE 120 may generate both RLF and SCGFailureInformation, and root cause analysis may be performed at previous (e.g., source) and target MN. In some aspects, transmitting the information that indicates the error during the CHO execution with the plurality of CPC or the plurality of CPA may include transmitting an indication that the CHO or CPC/CPA occurred when UE was configured with CHO with multiple CPC/CPA configuration. In one example, if SCG failure occurs, SCG failure information may be consumed locally at the target MN. Optionally, the SCG failure information may be forwarded to a previous MN. In another example, if RLF occurs, the UE 120 may generate an RLF report, and root cause analysis may be performed at the previous (e.g., source) and target MN.

As indicated above, FIG. 9 is provided as an example. Other examples may differ from what is described with regard to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with conditional handover and selective secondary cell group activation.

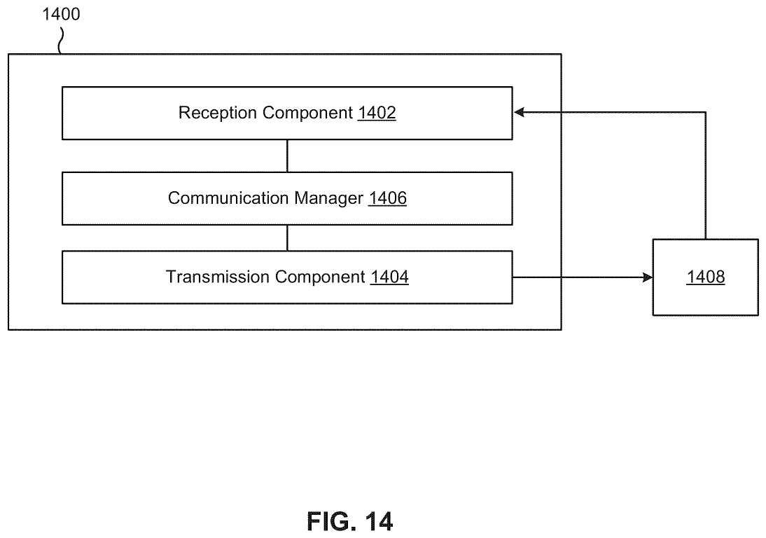

As shown in FIG. 10, in some aspects, process 1000 may include obtaining an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change (block 1010). For example, the UE (e.g., using reception component 1402 and/or communication manager 1406, depicted in FIG. 14) may obtain an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change, as described above.

As further shown in FIG. 10, in some aspects, process 1000 may include initiating the selective secondary cell group activation or the subsequent conditional handover (block 1020). For example, the UE (e.g., using communication manager 1406, depicted in FIG. 14) may initiate the selective secondary cell group activation or the subsequent conditional handover, as described above.

As further shown in FIG. 10, in some aspects, process 1000 may include detecting a failure occurrence associated with the selective secondary cell group activation or the subsequent conditional handover (block 1030). For example, the UE (e.g., using communication manager 1406, depicted in FIG. 14) may detect a failure occurrence associated with the selective secondary cell group activation or the subsequent conditional handover, as described above.

As further shown in FIG. 10, in some aspects, process 1000 may include transmitting, in accordance with detecting the failure occurrence associated with the selective secondary cell group activation or the subsequent conditional handover, information associated with the selective secondary cell group activation or the subsequent conditional handover (block 1040). For example, the UE (e.g., using transmission component 1404 and/or communication manager 1406, depicted in FIG. 14) may transmit, in accordance with detecting the failure occurrence associated with the selective secondary cell group activation or the subsequent conditional handover, information associated with the selective secondary cell group activation or the subsequent conditional handover, as described above.

Process 1000 may include additional aspects, such as any single aspect or any combination of aspects described below and/or in connection with one or more other processes described elsewhere herein.

In a first aspect, transmitting the information associated with the selective secondary cell group activation or the subsequent conditional handover comprises transmitting a self-organizing network report or a minimization of drive test report that includes the information associated with the selective secondary cell group activation or the subsequent conditional handover.

In a second aspect, alone or in combination with the first aspect, transmitting the information associated with the selective secondary cell group activation or the subsequent conditional handover comprises transmitting a previous primary secondary cell identifier associated with a subsequent conditional primary secondary cell change configuration or a subsequent conditional primary secondary cell addition configuration in accordance with detecting the failure occurrence associated with the selective secondary cell group activation, or transmitting a previous primary cell identifier associated with a subsequent conditional handover configuration in accordance with detecting a radio link failure.

In a third aspect, alone or in combination with one or more of the first and second aspects, transmitting the information associated with the selective secondary cell group activation or the subsequent conditional handover comprises transmitting timing information that indicates at least one of a time between detecting at least one of a master cell group indicator that indicates a handover failure or a secondary cell group radio link failure that indicates a primary secondary cell change failure or a primary secondary cell addition failure and at least one of a previous conditional handover, a previous conditional primary secondary cell change, or a previous conditional primary secondary cell addition, a time between receiving a previous selective secondary cell group activation or a subsequent conditional handover configuration and a delta configuration associated with a candidate cell, or a time between the delta configuration and a failure occurrence associated with a target primary cell or a target primary secondary cell.

In a fourth aspect, alone or in combination with one or more of the first through third aspects, transmitting the information associated with the selective secondary cell group activation or the subsequent conditional handover comprises transmitting an indication that the UE failed to comply with a delta configuration.

In a fifth aspect, alone or in combination with one or more of the first through fourth aspects, transmitting the information associated with the selective secondary cell group activation or the subsequent conditional handover comprises transmitting measurement associated with one or more stored measurements in accordance with detecting the failure occurrence.

In a sixth aspect, alone or in combination with one or more of the first through fifth aspects, process 1000 includes obtaining an indication of a plurality of reference configurations, associated with the selective secondary cell group activation or the subsequent conditional handover, for each candidate node of a plurality of candidate secondary nodes.

In a seventh aspect, alone or in combination with one or more of the first through sixth aspects, transmitting the information associated with the selective secondary cell group activation or the subsequent conditional handover comprises transmitting timing information that indicates at least one of a time between a previous configuration and a reference configuration update for each target cell of a plurality of target cells, or a time between a reference configuration update and detecting the failure occurrence for each target cell of the plurality of target cells.

In an eighth aspect, alone or in combination with one or more of the first through seventh aspects, transmitting the information associated with the selective secondary cell group activation or the subsequent conditional handover comprises transmitting an indication that the UE failed to comply with an updated reference configuration associated with the selective secondary cell group activation or the subsequent conditional handover.

In a ninth aspect, alone or in combination with one or more of the first through eighth aspects, process 1000 includes transmitting mobility history information that includes a flag that indicates at least one of whether a subsequent conditional handover was used for performing a handover or whether a conditional primary secondary cell change or conditional primary secondary cell addition was used for a primary secondary serving cell change or addition.

In a tenth aspect, alone or in combination with one or more of the first through ninth aspects, process 1000 includes receiving mobility history information that includes a flag that indicates at least one of whether a subsequent conditional handover was used for performing a handover or whether a conditional primary secondary cell change or conditional primary secondary cell addition was used for a primary secondary cell change or addition.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with conditional handover and selective secondary cell group activation.

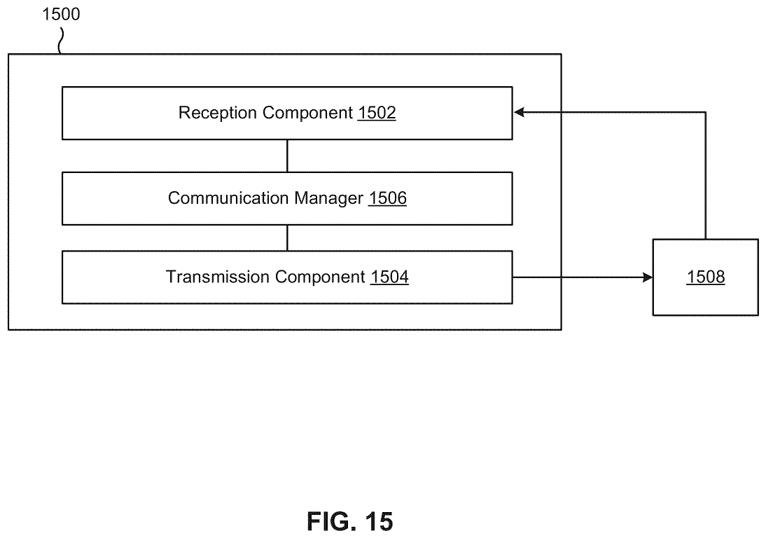

As shown in FIG. 11, in some aspects, process 1100 may include identifying a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change (block 1110). For example, the network node (e.g., using communication manager 1506, depicted in FIG. 15) may identify a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change, as described above.

As further shown in FIG. 11, in some aspects, process 1100 may include transmitting a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error (block 1120). For example, the network node (e.g., using transmission component 1504 and/or communication manager 1506, depicted in FIG. 15) may transmit a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error, as described above.

Process 1100 may include additional aspects, such as any single aspect or any combination of aspects described below and/or in connection with one or more other processes described elsewhere herein.

In a first aspect, identifying the handover failure, the radio link failure, the secondary cell group radio link failure, or the primary secondary cell change failure comprises identifying the handover failure or the radio link failure in accordance with detecting the subsequent conditional handover configuration formulation error during the subsequent conditional handover, and transmitting the selective secondary cell group activation failure indicator comprises identifying the secondary cell group radio link failure or the primary secondary cell change failure in accordance with detecting a selective secondary cell group activation configuration formulation error during a conditional primary secondary cell change.

In a second aspect, alone or in combination with the first aspect, transmitting the subsequent conditional handover failure indicator comprises transmitting the subsequent conditional handover failure indicator from a master node associated with the network node to one or more candidate master nodes, wherein a root cause analysis is performed at the master node or the one or more candidate master nodes in accordance with a subsequent conditional handover configuration being determined by the master node or the one or more candidate master nodes.

In a third aspect, alone or in combination with one or more of the first and second aspects, transmitting the selective secondary cell group activation failure indicator comprises transmitting the selective secondary cell group activation failure indicator from master node associated with the network node to one or more candidate secondary nodes, wherein a root cause analysis is performed at the master node or the one or more candidate secondary nodes in accordance with a selective secondary cell group activation failure being determined by the master node and the one or more candidate secondary nodes.

In a fourth aspect, alone or in combination with one or more of the first through third aspects, transmitting the selective secondary cell group activation failure indicator comprises transmitting the selective secondary cell group activation failure indicator from a source secondary node associated with the network node to one or more candidate secondary nodes, wherein a root cause analysis is performed at the source secondary node and the one or more candidate secondary nodes in accordance with a selective secondary cell group activation failure being determined by the source secondary node and the one or more candidate secondary nodes.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with conditional handover and selective secondary cell group activation.

As shown in FIG. 12, in some aspects, process 1200 may include obtaining an indication to perform a conditional handover in accordance with a conditional handover configuration with a plurality of conditional primary secondary cell change configurations or a plurality of conditional primary secondary cell addition configurations (block 1210). For example, the UE (e.g., using reception component 1402 and/or communication manager 1406, depicted in FIG. 14) may obtain an indication to perform a conditional handover in accordance with a conditional handover configuration with a plurality of conditional primary secondary cell change configurations or a plurality of conditional primary secondary cell addition configurations, as described above.

As further shown in FIG. 12, in some aspects, process 1200 may include initiating the conditional handover and at least one of a conditional primary secondary cell change associated with the plurality of conditional primary secondary cell change configurations or a conditional primary secondary cell addition associated with the plurality of conditional primary secondary cell addition configurations (block 1220). For example, the UE (e.g., using communication manager 1406, depicted in FIG. 14) may initiate the conditional handover and at least one of a conditional primary secondary cell change associated with the plurality of conditional primary secondary cell change configurations or a conditional primary secondary cell addition associated with the plurality of conditional primary secondary cell addition configurations, as described above.

As further shown in FIG. 12, in some aspects, process 1200 may include detecting a failure occurrence associated with the conditional handover, or at least one of the conditional primary secondary cell change or the conditional primary secondary cell addition (block 1230). For example, the UE (e.g., using communication manager 1406, depicted in FIG. 14) may detect a failure occurrence associated with the conditional handover, or at least one of the conditional primary secondary cell change or the conditional primary secondary cell addition, as described above.

As further shown in FIG. 12, in some aspects, process 1200 may include transmitting, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations (block 1240). For example, the UE (e.g., using transmission component 1404 and/or communication manager 1406, depicted in FIG. 14) may transmit, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations, as described above.

Process 1200 may include additional aspects, such as any single aspect or any combination of aspects described below and/or in connection with one or more other processes described elsewhere herein.

In a first aspect, transmitting the information associated with the conditional handover configuration comprises transmitting, in accordance with detecting a radio link failure, information associated with the conditional handover configuration that includes the plurality of conditional primary secondary cell change configurations.

In a second aspect, alone or in combination with the first aspect, transmitting the information associated with the conditional handover configuration comprises transmitting, for each conditional primary cell change configuration of the plurality of conditional primary secondary cell change configurations, at least one of an indication of whether an execution condition for a primary cell identifier has been satisfied, an indication of an execution event that has been satisfied for a primary cell identifier or a primary secondary cell identifier, an indication of a time gap between two or more configured events that have been satisfied for a primary cell identifier or a primary secondary cell identifier, an indication of whether an execution condition for a primary secondary serving cell identifier has been satisfied, or an indication of one or more conditional handover execution conditions, one or more primary secondary cell change execution conditions, or one or more conditional primary cell addition execution conditions.

In a third aspect, alone or in combination with one or more of the first and second aspects, transmitting the information associated with the conditional handover configuration comprises transmitting timing information that indicates at least one of a time between a radio link failure and a trigger condition associated with at least one of a condition handover, a conditional primary secondary cell change, or a conditional primacy secondary cell addition being satisfied, or a time between a conditional handover execution condition being satisfied and a conditional primary secondary cell change or conditional primary secondary cell addition execution condition being satisfied.

In a fourth aspect, alone or in combination with one or more of the first through third aspects, transmitting the information associated with the conditional handover configuration comprises transmitting measurement information that indicates one or more primary cell measurements and one or more primary secondary cell measurements.

In a fifth aspect, alone or in combination with one or more of the first through fourth aspects, transmitting the information associated with the conditional handover configuration comprises transmitting an indication of whether a legacy conditional handover only is configured or whether a legacy conditional handover with secondary cell group is configured.

In a sixth aspect, alone or in combination with one or more of the first through fifth aspects, transmitting the information associated with the conditional handover configuration comprises transmitting secondary cell group failure information to a target master node after a successful handover.

In a seventh aspect, alone or in combination with one or more of the first through sixth aspects, process 1200 includes transmitting an indication of a most recent primary secondary cell change associated with the conditional handover.

In an eighth aspect, alone or in combination with one or more of the first through seventh aspects, transmitting the information associated with the conditional handover configuration comprises transmitting at least one of a trigger condition associated with an SHR or a trigger condition associated with an SPR.

In a ninth aspect, alone or in combination with one or more of the first through eighth aspects, transmitting the trigger condition associated with the SHR comprises transmitting an indication to generate the SHR in accordance with a legacy conditional handover only, or to generate the SHR in accordance with a legacy conditional handover with a secondary cell group based at least in part on the UE being configured with a conditional handover configuration that includes a plurality of conditional primary secondary cell change configurations or a plurality of conditional primary secondary cell addition configurations.

In a tenth aspect, alone or in combination with one or more of the first through ninth aspects, transmitting the trigger condition associated with the SHR comprises transmitting at least one of an indication that a handover is performed using a legacy conditional handover only configuration and that the UE is configured with conditional handover configuration that includes a plurality of conditional primary secondary cell change configurations or a plurality of conditional primary secondary cell addition configurations, an indication that a handover is performed using a legacy conditional handover with secondary cell group configuration and that the UE is configured with conditional handover configuration that includes a plurality of conditional primary secondary cell change configurations or a plurality of conditional primary secondary cell addition configurations, an indication of one or more primary cell measurements or one or more primary secondary cell measurements, or an indication to identify a secondary cell group failure occurrence during a successful conditional handover based at least in part on a handover being performed using a conditional handover configuration that includes a plurality of conditional primary secondary cell change configurations or a plurality of conditional primary secondary cell addition configurations.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with conditional handover and selective secondary cell group activation.

As shown in FIG. 13, in some aspects, process 1300 may include identifying an error during a conditional handover execution with a plurality of conditional primary secondary cell change or a plurality of conditional primary secondary cell addition (block 1310). For example, the UE (e.g., using communication manager 1406, depicted in FIG. 14) may identify an error during a conditional handover execution with a plurality of conditional primary secondary cell change or a plurality of conditional primary secondary cell addition, as described above.

As further shown in FIG. 13, in some aspects, process 1300 may include transmitting information that indicates the error during the conditional handover execution with the plurality of conditional primary secondary cell change or the plurality of conditional primary secondary cell addition (block 1320). For example, the UE (e.g., using transmission component 1404 and/or communication manager 1406, depicted in FIG. 14) may transmit information that indicates the error during the conditional handover execution with the plurality of conditional primary secondary cell change or the plurality of conditional primary secondary cell addition, as described above.

Process 1300 may include additional aspects, such as any single aspect or any combination of aspects described below and/or in connection with one or more other processes described elsewhere herein.

In a first aspect, identifying the error during the conditional handover execution with the plurality of conditional primary secondary cell change or the plurality of conditional primary secondary cell addition comprises identifying a conditional primary secondary cell change or conditional primary secondary cell addition failure, wherein the conditional handover or the conditional primary secondary cell change or conditional primary secondary cell addition was not performed based at least in part on execution conditions for the conditional handover and the conditional primary secondary cell change or conditional primary secondary cell addition failure were not satisfied within a configured time span.

In a second aspect, alone or in combination with the first aspect, process 1300 includes selecting, in accordance with performing a handover, a legacy conditional handover only configuration or a legacy conditional handover with a secondary cell group configuration, and generating a successful handover report in accordance with completing the handover, wherein transmitting the information that indicates the error during the conditional handover execution with the plurality of conditional primary secondary cell change or the plurality of conditional primary secondary cell addition comprises transmitting a successful handover report that includes information for optimizing the conditional handover associated with the plurality of conditional primary secondary cell change configurations or the plurality of conditional primary secondary cell addition configurations.

In a third aspect, alone or in combination with one or more of the first and second aspects, process 1300 includes detecting a radio link failure, and generating a radio link failure report, wherein transmitting the information that indicates the error during the conditional handover execution with the plurality of conditional primary secondary cell change or the plurality of conditional primary secondary cell addition, comprises transmitting a radio link failure report that includes information for optimizing the conditional handover configuration with the plurality of conditional primary secondary cell change configurations or the plurality of conditional primary secondary cell addition configurations.

In a fourth aspect, alone or in combination with one or more of the first through third aspects, identifying the error during the conditional handover execution with the plurality of conditional primary secondary cell change or the plurality of conditional primary secondary cell addition comprises identifying that the conditional handover and conditional primary secondary cell change or conditional primary secondary cell addition execution resulted in conditional handover failure or conditional primary secondary cell change or conditional primary secondary cell addition failure, wherein a conditional handover failure or radio link failure is identified after a successful conditional handover is detected on primary cell and a measurement indicates that a source primary cell is a suitable cell, or wherein a primary secondary cell addition or change failure or a secondary cell group radio link failure is identified after a successful conditional primary secondary cell change or conditional primary secondary cell addition based at least in part on a measurement indicating that a source primary secondary cell is a suitable cell.

In a fifth aspect, alone or in combination with one or more of the first through fourth aspects, process 1300 includes detecting a secondary cell group failure, wherein transmitting the information that indicates the error during the conditional handover execution with the plurality of conditional primary secondary cell change or the plurality of conditional primary secondary cell addition comprises transmitting a secondary cell group failure indication to a target primary cell after a successful conditional handover that includes the information that indicates the error during the conditional handover execution with the plurality of conditional primary secondary cell change or the plurality of conditional primary secondary cell addition.

In a sixth aspect, alone or in combination with one or more of the first through fifth aspects, process 1300 includes detecting radio link failure, wherein transmitting the information that indicates the error during the conditional handover execution with the plurality of conditional primary secondary cell change or the plurality of conditional primary secondary cell addition comprises transmitting a radio link failure indication that includes the information that indicates the error during the conditional handover execution with the plurality of conditional primary secondary cell change or the plurality of conditional primary secondary cell addition.

In a seventh aspect, alone or in combination with one or more of the first through sixth aspects, identifying the error during the conditional handover execution with the plurality of conditional primary secondary cell change or the plurality of conditional primary secondary cell addition comprises identifying a conditional handover to an incorrect primary cell or identifying a conditional primary secondary change or addition to an incorrect primary secondary cell, wherein a conditional handover failure or radio link failure is detected after a successful conditional handover based at least in part on a primary cell measurement indicating that another primary cell other than a source primary cell and a target primary cell is a suitable cell, or wherein a primary secondary cell change or addition failure or a secondary cell group radio link failure is identified after a successful conditional primary secondary cell change or conditional primary secondary cell addition based at least in part on a primary secondary cell measurement indicating that another primary secondary cell other than a source primary cell and a target primary secondary cell is a suitable cell.

In an eighth aspect, alone or in combination with one or more of the first through seventh aspects, process 1300 includes transmitting a received secondary cell group failure information report to a source primary cell, wherein a root cause analysis is performed at a target primary cell based at least in part on the received secondary cell group failure information report.

In a ninth aspect, alone or in combination with one or more of the first through eighth aspects, process 1300 includes transmitting a received radio link failure report to a source primary cell or a target primary cell for root cause analysis.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 5-9. Additionally, or alternatively, the apparatus 1400 may be configured to perform one or more processes described herein, such as process 1000 of FIG. 10, process 1200 of FIG. 12, process 1300 of FIG. 13, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may obtain an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change. The communication manager 1406 may initiate the selective secondary cell group activation or the subsequent conditional handover. The communication manager 1406 may detect a failure occurrence associated with the selective secondary cell group activation or the subsequent conditional handover. The transmission component 1404 may transmit, in accordance with detecting the failure occurrence associated with the selective secondary cell group activation or the subsequent conditional handover, information associated with the selective secondary cell group activation or the subsequent conditional handover.

The reception component 1402 may obtain an indication of a plurality of reference configurations, associated with the selective secondary cell group activation or the subsequent conditional handover, for each candidate node of a plurality of candidate secondary nodes. The transmission component 1404 may transmit mobility history information that includes a flag that indicates at least one of whether a subsequent conditional handover was used for performing a handover or whether a conditional primary secondary cell change or conditional primary secondary cell addition was used for a primary secondary serving cell change or addition. The reception component 1402 may receive mobility history information that includes a flag that indicates at least one of whether a subsequent conditional handover was used for performing a handover or whether a conditional primary secondary cell change or conditional primary secondary cell addition was used for a primary secondary cell change or addition.

The reception component 1402 may obtain an indication to perform a conditional handover in accordance with a conditional handover configuration with a plurality of conditional primary secondary cell change configurations or a plurality of conditional primary secondary cell addition configurations. The communication manager 1406 may initiate the conditional handover and at least one of a conditional primary secondary cell change associated with the plurality of conditional primary secondary cell change configurations or a conditional primary secondary cell addition associated with the plurality of conditional primary secondary cell addition configurations. The communication manager 1406 may detect a failure occurrence associated with the conditional handover, or at least one of the conditional primary secondary cell change or the conditional primary secondary cell addition. The transmission component 1404 may transmit, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations. The transmission component 1404 may transmit an indication of a most recent primary secondary cell change associated with the conditional handover.

The communication manager 1406 may identify an error during a conditional handover execution with a plurality of conditional primary secondary cell change or a plurality of conditional primary secondary cell addition. The transmission component 1404 may transmit information that indicates the error during the conditional handover execution with the plurality of conditional primary secondary cell change or the plurality of conditional primary secondary cell addition.

The communication manager 1406 may select, in accordance with performing a handover, a legacy conditional handover only configuration or a legacy conditional handover with a secondary cell group configuration. The communication manager 1406 may generate a successful handover report in accordance with completing the handover, wherein transmitting the information that indicates the error during the conditional handover execution with the plurality of conditional primary secondary cell change or the plurality of conditional primary secondary cell addition comprises transmitting a successful handover report that includes information for optimizing the conditional handover configuration with the plurality of conditional primary secondary cell change configurations or the plurality of conditional primary secondary cell addition configurations. The communication manager 1406 may detect a radio link failure. The communication manager 1406 may generate a radio link failure report, wherein transmitting the information that indicates the error during the conditional handover execution with the plurality of conditional primary secondary cell change or the plurality of conditional primary secondary cell addition, comprises transmitting a radio link failure report that includes information for optimizing the conditional handover configuration with the plurality of conditional primary secondary cell change configurations or the plurality of conditional primary secondary cell addition configurations.

The communication manager 1406 may detect a secondary cell group failure, wherein transmitting the information that indicates the error during the conditional handover execution with the plurality of conditional primary secondary cell change or the plurality of conditional primary secondary cell addition comprises transmitting a secondary cell group failure indication to a target primary cell after a successful conditional handover that includes the information that indicates the error during the conditional handover execution with the plurality of conditional primary secondary cell change or the plurality of conditional primary secondary cell addition. The transmission component 1404 may transmit a received secondary cell group failure information report to a source primary cell, wherein a root cause analysis is performed at a target primary cell based at least in part on the received secondary cell group failure information report. The transmission component 1404 may transmit a received radio link failure report to a source primary cell or a target primary cell for root cause analysis.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 5-9. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The communication manager 1506 may identify a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change. The transmission component 1504 may transmit a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: obtaining an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change; initiating the selective secondary cell group activation or the subsequent conditional handover; detecting a failure occurrence associated with the selective secondary cell group activation or the subsequent conditional handover; and transmitting, in accordance with detecting the failure occurrence associated with the selective secondary cell group activation or the subsequent conditional handover, information associated with the selective secondary cell group activation or the subsequent conditional handover.

Aspect 2: The method of Aspect 1, wherein transmitting the information associated with the selective secondary cell group activation or the subsequent conditional handover comprises transmitting a self-organizing network report or a minimization of drive test report that includes the information associated with the selective secondary cell group activation or the subsequent conditional handover.

Aspect 3: The method of any of Aspects 1-2, wherein transmitting the information associated with the selective secondary cell group activation or the subsequent conditional handover comprises: transmitting a previous primary secondary cell identifier associated with a subsequent conditional primary secondary cell change configuration or a subsequent conditional primary secondary cell addition configuration in accordance with detecting the failure occurrence associated with the selective secondary cell group activation; or transmitting a previous primary cell identifier associated with a subsequent conditional handover configuration in accordance with detecting a radio link failure.

Aspect 4: The method of any of Aspects 1-3, wherein transmitting the information associated with the selective secondary cell group activation or the subsequent conditional handover comprises transmitting timing information that indicates at least one of: a time between detecting at least one of a master cell group indicator that indicates a handover failure or a secondary cell group radio link failure that indicates a primary secondary cell change failure or a primary secondary cell addition failure and at least one of a previous conditional handover, a previous conditional primary secondary cell change, or a previous conditional primary secondary cell addition; a time between receiving a previous selective secondary cell group activation or a subsequent conditional handover configuration and a delta configuration associated with a candidate cell; or a time between the delta configuration and a failure occurrence associated with a target primary cell or a target primary secondary cell.

Aspect 5: The method of any of Aspects 1-4, wherein transmitting the information associated with the selective secondary cell group activation or the subsequent conditional handover comprises transmitting an indication that the UE failed to comply with a delta configuration.

Aspect 6: The method of any of Aspects 1-5, wherein transmitting the information associated with the selective secondary cell group activation or the subsequent conditional handover comprises transmitting measurement associated with one or more stored measurements in accordance with detecting the failure occurrence.

Aspect 7: The method of any of Aspects 1-6, further comprising obtaining an indication of a plurality of reference configurations, associated with the selective secondary cell group activation or the subsequent conditional handover, for each candidate node of a plurality of candidate secondary nodes.

Aspect 8: The method of Aspect 7, wherein transmitting the information associated with the selective secondary cell group activation or the subsequent conditional handover comprises transmitting timing information that indicates at least one of: a time between a previous configuration and a reference configuration update for each target cell of a plurality of target cells; or a time between a reference configuration update and detecting the failure occurrence for each target cell of the plurality of target cells.

Aspect 9: The method of Aspect 7, wherein transmitting the information associated with the selective secondary cell group activation or the subsequent conditional handover comprises transmitting an indication that the UE failed to comply with an updated reference configuration associated with the selective secondary cell group activation or the subsequent conditional handover.

Aspect 10: The method of any of Aspects 1-9, further comprising transmitting mobility history information that includes a flag that indicates at least one of whether a subsequent conditional handover was used for performing a handover or whether a conditional primary secondary cell change or conditional primary secondary cell addition was used for a primary secondary serving cell change or addition.

Aspect 11: The method of any of Aspects 1-10, further comprising receiving mobility history information that includes a flag that indicates at least one of whether a subsequent conditional handover was used for performing a handover or whether a conditional primary secondary cell change or conditional primary secondary cell addition was used for a primary secondary cell change or addition.

Aspect 12: A method of wireless communication performed by a network node, comprising: identifying a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and transmitting a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error.

Aspect 13: The method of Aspect 12, wherein identifying the handover failure, the radio link failure, the secondary cell group radio link failure, or the primary secondary cell change failure comprises identifying the handover failure or the radio link failure in accordance with detecting the subsequent conditional handover configuration formulation error during the subsequent conditional handover, and wherein transmitting the selective secondary cell group activation failure indicator comprises identifying the secondary cell group radio link failure or the primary secondary cell change failure in accordance with detecting a selective secondary cell group activation configuration formulation error during a conditional primary secondary cell change.

Aspect 14: The method of Aspect 13, wherein transmitting the subsequent conditional handover failure indicator comprises transmitting the subsequent conditional handover failure indicator from a master node associated with the network node to one or more candidate master nodes, wherein a root cause analysis is performed at the master node or the one or more candidate master nodes in accordance with a subsequent conditional handover configuration being determined by the master node or the one or more candidate master nodes.

Aspect 15: The method of Aspect 13, wherein transmitting the selective secondary cell group activation failure indicator comprises transmitting the selective secondary cell group activation failure indicator from master node associated with the network node to one or more candidate secondary nodes, wherein a root cause analysis is performed at the master node or the one or more candidate secondary nodes in accordance with a selective secondary cell group activation failure being determined by the master node and the one or more candidate secondary nodes.

Aspect 16: The method of Aspect 13, wherein transmitting the selective secondary cell group activation failure indicator comprises transmitting the selective secondary cell group activation failure indicator from a source secondary node associated with the network node to one or more candidate secondary nodes, wherein a root cause analysis is performed at the source secondary node and the one or more candidate secondary nodes in accordance with a selective secondary cell group activation failure being determined by the source secondary node and the one or more candidate secondary nodes.

Aspect 17: A method of wireless communication performed by a user equipment (UE), comprising: obtaining an indication to perform a conditional handover in accordance with a conditional handover configuration with a plurality of conditional primary secondary cell change configurations or a plurality of conditional primary secondary cell addition configurations; initiating the conditional handover and at least one of a conditional primary secondary cell change associated with the plurality of conditional primary secondary cell change configurations or a conditional primary secondary cell addition associated with the plurality of conditional primary secondary cell addition configurations; detecting a failure occurrence associated with the conditional handover, or at least one of the conditional primary secondary cell change or the conditional primary secondary cell addition; and transmitting, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations.

Aspect 18: The method of Aspect 17, wherein transmitting the information associated with the conditional handover configuration comprises transmitting, in accordance with detecting a radio link failure, information associated with the conditional handover configuration that includes the plurality of conditional primary secondary cell change configurations.

Aspect 19: The method of Aspect 18, wherein transmitting the information associated with the conditional handover configuration comprises transmitting, for each conditional primary cell change configuration of the plurality of conditional primary secondary cell change configurations, at least one of: an indication of whether an execution condition for a primary cell identifier has been satisfied; an indication of an execution event that has been satisfied for a primary cell identifier or a primary secondary cell identifier; an indication of a time gap between two or more configured events that have been satisfied for a primary cell identifier or a primary secondary cell identifier; an indication of whether an execution condition for a primary secondary serving cell identifier has been satisfied; or an indication of one or more conditional handover execution conditions, one or more primary secondary cell change execution conditions, or one or more conditional primary cell addition execution conditions.

Aspect 20: The method of Aspect 18, wherein transmitting the information associated with the conditional handover configuration comprises transmitting timing information that indicates at least one of: a time between a radio link failure and a trigger condition associated with at least one of a condition handover, a conditional primary secondary cell change, or a conditional primacy secondary cell addition being satisfied; or a time between a conditional handover execution condition being satisfied and a conditional primary secondary cell change or conditional primary secondary cell addition execution condition being satisfied.

Aspect 21: The method of Aspect 18, wherein transmitting the information associated with the conditional handover configuration comprises transmitting measurement information that indicates one or more primary cell measurements and one or more primary secondary cell measurements.

Aspect 22: The method of Aspect 18, wherein transmitting the information associated with the conditional handover configuration comprises transmitting an indication of whether a legacy conditional handover only is configured or whether a legacy conditional handover with secondary cell group is configured.

Aspect 23: The method of Aspect 18, wherein transmitting the information associated with the conditional handover configuration comprises transmitting secondary cell group failure information to a target master node after a successful handover.

Aspect 24: The method of Aspect 23, further comprising transmitting an indication of a most recent primary secondary cell change associated with the conditional handover.

Aspect 25: The method of any of Aspects 17-24, wherein transmitting the information associated with the conditional handover configuration comprises transmitting at least one of a trigger condition associated with a successful handover report (SHR) or a trigger condition associated with a successful primary cell change report (SPR).

Aspect 26: The method of Aspect 25, wherein transmitting the trigger condition associated with the SHR comprises transmitting an indication to generate the SHR in accordance with a legacy conditional handover only, or to generate the SHR in accordance with a legacy conditional handover with a secondary cell group based at least in part on the UE being configured with a conditional handover configuration that includes a plurality of conditional primary secondary cell change configurations or a plurality of conditional primary secondary cell addition configurations.

Aspect 27: The method of Aspect 25, wherein transmitting the trigger condition associated with the SHR comprises transmitting at least one of: an indication that a handover is performed using a legacy conditional handover only configuration and that the UE is configured with conditional handover configuration that includes a plurality of conditional primary secondary cell change configurations or a plurality of conditional primary secondary cell addition configurations; an indication that a handover is performed using a legacy conditional handover with secondary cell group configuration and that the UE is configured with conditional handover configuration that includes a plurality of conditional primary secondary cell change configurations or a plurality of conditional primary secondary cell addition configurations; an indication of one or more primary cell measurements or one or more primary secondary cell measurements; or an indication to identify a secondary cell group failure occurrence during a successful conditional handover based at least in part on a handover being performed using a conditional handover configuration that includes a plurality of conditional primary secondary cell change configurations or a plurality of conditional primary secondary cell addition configurations.

Aspect 28: A method of wireless communication performed by a user equipment (UE), comprising: identifying an error during a conditional handover execution with a plurality of conditional primary secondary cell change or a plurality of conditional primary secondary cell addition; and transmitting information that indicates the error during the conditional handover execution with the plurality of conditional primary secondary cell change or the plurality of conditional primary secondary cell addition.

Aspect 29: The method of Aspect 28, wherein identifying the error during the conditional handover execution with the plurality of conditional primary secondary cell change or the plurality of conditional primary secondary cell addition comprises identifying that the conditional handover and conditional primary secondary cell change or conditional primary secondary cell addition were not performed, wherein the conditional handover or the conditional primary secondary cell change or conditional primary secondary cell addition was not performed based at least in part on execution conditions for the conditional handover and the conditional primary secondary cell change or conditional primary secondary cell addition failure were not satisfied within a configured time span.

Aspect 30: The method of any of Aspects 28-29, further comprising: selecting, in accordance with performing a handover, a legacy conditional handover only configuration or a legacy conditional handover with a secondary cell group configuration; and generating a successful handover report in accordance with completing the handover, wherein transmitting the information that indicates the error during the conditional handover execution with the plurality of conditional primary secondary cell change or the plurality of conditional primary secondary cell addition comprises transmitting a successful handover report that includes information for optimizing the conditional handover configuration with the plurality of conditional primary secondary cell change configurations or the plurality of conditional primary secondary cell addition configurations.

Aspect 31: The method of any of Aspects 28-30, further comprising: detecting a radio link failure; and generating a radio link failure report, wherein transmitting the information that indicates the error during the conditional handover execution with the plurality of conditional primary secondary cell change or the plurality of conditional primary secondary cell addition, comprises transmitting a radio link failure report that includes information for optimizing the conditional handover configuration with the plurality of conditional primary secondary cell change configurations or the plurality of conditional primary secondary cell addition configurations.

Aspect 32: The method of any of Aspects 28-31, wherein identifying the error during the conditional handover execution with the plurality of conditional primary secondary cell change or the plurality of conditional primary secondary cell addition comprises identifying that the conditional handover and conditional primary secondary cell change or conditional primary secondary cell addition execution resulted in conditional handover execution failure or conditional primary secondary cell change or conditional primary secondary cell addition execution failure, wherein a conditional handover failure or radio link failure is identified after a successful conditional handover is detected on primary cell and a measurement indicates that a source primary cell is a suitable cell, or wherein a primary secondary cell addition or change failure or a secondary cell group radio link failure is identified after a successful conditional primary secondary cell change or conditional primary secondary cell addition based at least in part on a measurement indicating that a source primary secondary cell is a suitable cell.

Aspect 33: The method of Aspect 32, further comprising detecting a secondary cell group failure, wherein transmitting the information that indicates the error during the conditional handover execution with the plurality of conditional primary secondary cell change or the plurality of conditional primary secondary cell addition comprises transmitting a secondary cell group failure indication to a target primary cell after a successful conditional handover that includes the information that indicates the error during the conditional handover execution with the plurality of conditional primary secondary cell change or the plurality of conditional primary secondary cell addition.

Aspect 34: The method of Aspect 32, further comprising detecting radio link failure, wherein transmitting the information that indicates the error during the conditional handover execution with the plurality of conditional primary secondary cell change or the plurality of conditional primary secondary cell addition comprises transmitting a radio link failure indication that includes the information that indicates the error during the conditional handover execution with the plurality of conditional primary secondary cell change or the plurality of conditional primary secondary cell addition.

Aspect 35: The method of any of Aspects 28-34, wherein identifying the error during the conditional handover execution with the plurality of conditional primary secondary cell change or the plurality of conditional primary secondary cell addition comprises identifying a conditional handover to an incorrect primary cell or identifying a conditional primary secondary change or addition to an incorrect primary secondary cell, wherein a conditional handover failure or radio link failure is detected after a successful conditional handover based at least in part on a primary cell measurement indicating that another primary cell other than a source primary cell and a target primary cell is a suitable cell, or wherein a primary secondary cell change or addition failure or a secondary cell group radio link failure is identified after a successful conditional primary secondary cell change or conditional primary secondary cell addition based at least in part on a primary secondary cell measurement indicating that another primary secondary cell other than a source primary cell and a target primary secondary cell is a suitable cell.

Aspect 36: The method of any of Aspects 28-35, further comprising transmitting a received secondary cell group failure information report to a source primary cell, wherein a root cause analysis is performed at a target primary cell based at least in part on the received secondary cell group failure information report.

Aspect 37: The method of any of Aspects 28-36, further comprising transmitting a received radio link failure report to a source primary cell or a target primary cell for root cause analysis.

Aspect 38: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-37.

Aspect 39: An apparatus for wireless communication at a device, the apparatus comprising one or more memories and one or more processors coupled to the one or more memories, the one or more processors configured to cause the device to perform the method of one or more of Aspects 1-37.

Aspect 40: An apparatus for wireless communication, the apparatus comprising at least one means for performing the method of one or more of Aspects 1-37.

Aspect 41: A non-transitory computer-readable medium storing code for wireless communication, the code comprising instructions executable by one or more processors to perform the method of one or more of Aspects 1-37.

Aspect 42: A non-transitory computer-readable medium storing a set of instructions for wireless communication, the set of instructions comprising one or more instructions that, when executed by one or more processors of a device, cause the device to perform the method of one or more of Aspects 1-37.

Aspect 43: A device for wireless communication, the device comprising a processing system that includes one or more processors and one or more memories coupled with the one or more processors, the processing system configured to cause the device to perform the method of one or more of Aspects 1-37.

Aspect 44: An apparatus for wireless communication at a device, the apparatus comprising one or more memories and one or more processors coupled to the one or more memories, the one or more processors individually or collectively configured to cause the device to perform the method of one or more of Aspects 1-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, the one or more processors individually or collectively configured to cause the UE to:
obtain an indication to perform a selective secondary cell group activation or a subsequent conditional handover associated with a subsequent conditional primary cell change, the subsequent conditional handover associated with the subsequent conditional primary cell change being performed after a previous conditional handover associated with a previous conditional primary cell change;
initiate the selective secondary cell group activation or the subsequent conditional handover;
detect a failure occurrence associated with the selective secondary cell group activation or the subsequent conditional handover; and
transmit, in accordance with detecting the failure occurrence associated with the selective secondary cell group activation or the subsequent conditional handover, information associated with the selective secondary cell group activation or the subsequent conditional handover.

2. The UE of claim 1, wherein the one or more processors, to cause the UE to transmit the information associated with the selective secondary cell group activation or the subsequent conditional handover, are configured to cause the UE to transmit a self-organizing network report or a minimization of drive test report that includes the information associated with the selective secondary cell group activation or the subsequent conditional handover.

3. The UE of claim 1, wherein the one or more processors, to cause the UE to transmit the information associated with the selective secondary cell group activation or the subsequent conditional handover, are configured to cause the UE to:
transmit a previous primary secondary cell identifier associated with a subsequent conditional primary secondary cell change configuration or a subsequent conditional primary secondary cell addition configuration in accordance with detecting the failure occurrence associated with the selective secondary cell group activation; or
transmit a previous primary cell identifier associated with a subsequent conditional handover configuration in accordance with detecting a radio link failure.

4. The UE of claim 1, wherein the one or more processors, to cause the UE to transmit the information associated with the selective secondary cell group activation or the subsequent conditional handover, are configured to cause the UE to transmit timing information that indicates at least one of:
a time between detecting at least one of a master cell group indicator that indicates a handover failure or a secondary cell group radio link failure that indicates a primary secondary cell change failure or a primary secondary cell addition failure and at least one of a previous conditional handover, a previous conditional primary secondary cell change, or a previous conditional primary secondary cell addition;
a time between receiving a previous selective secondary cell group activation or a subsequent conditional handover configuration and a delta configuration associated with a candidate cell; or
a time between the delta configuration and a failure occurrence associated with a target primary cell or a target primary secondary cell.

5. The UE of claim 1, wherein the one or more processors, to cause the UE to transmit the information associated with the selective secondary cell group activation or the subsequent conditional handover, are configured to cause the UE to transmit an indication that the UE failed to comply with a delta configuration.

6. The UE of claim 1, wherein the one or more processors, to cause the UE to transmit the information associated with the selective secondary cell group activation or the subsequent conditional handover, are configured to cause the UE to transmit measurement associated with one or more stored measurements in accordance with detecting the failure occurrence.

7. The UE of claim 1, wherein the one or more processors are further configured to cause the UE to obtain an indication of a plurality of reference configurations, associated with the selective secondary cell group activation or the subsequent conditional handover, for each candidate node of a plurality of candidate secondary nodes.

8. The UE of claim 7, wherein the one or more processors, to cause the UE to transmit the information associated with the selective secondary cell group activation or the subsequent conditional handover, are configured to cause the UE to transmit timing information that indicates at least one of:
a time between a previous configuration and a reference configuration update for each target cell of a plurality of target cells; or
a time between a reference configuration update and detecting the failure occurrence for each target cell of the plurality of target cells.

9. The UE of claim 7, wherein the one or more processors, to cause the UE to transmit the information associated with the selective secondary cell group activation or the subsequent conditional handover, are configured to cause the UE to transmit an indication that the UE failed to comply with an updated reference configuration associated with the selective secondary cell group activation or the subsequent conditional handover.

10. The UE of claim 1, wherein the one or more processors are further configured to cause the UE to:
transmit mobility history information that includes a flag that indicates at least one of whether a subsequent conditional handover was used for performing a handover or whether a conditional primary secondary cell change or conditional primary secondary cell addition was used for a primary secondary serving cell change or addition; or
receive mobility history information that includes a flag that indicates at least one of whether a subsequent conditional handover was used for performing a handover or whether a conditional primary secondary cell change or conditional primary secondary cell addition was used for a primary secondary cell change or addition.

11. A network node for wireless communication, comprising:
one or more memories; and
one or more processors, coupled to the one or more memories, the one or more processors individually or collectively configured to cause the network node to:
identify a radio link failure, a handover failure, a secondary cell group radio link failure, or a primary secondary cell change failure, the radio link failure or the handover failure being associated with a subsequent conditional handover configuration formulation error during a subsequent conditional handover, and the primary secondary cell change failure being associated with a selective secondary cell group activation configuration formulation error during a conditional primary secondary cell change; and
transmit a subsequent conditional handover failure indicator that indicates the radio link failure or the handover failure, or a selective secondary cell group activation failure indicator that indicates the secondary cell group radio link failure or the primary secondary cell change failure, wherein transmitting the subsequent conditional handover failure indicator comprises transmitting the subsequent conditional handover failure indicator in accordance with detecting the subsequent conditional handover configuration formulation error, and transmitting the selective secondary cell group activation failure indicator comprises transmitting the selective secondary cell group activation failure indicator in accordance with detecting the selective secondary cell group activation configuration formulation error.

12. The network node of claim 11, wherein the one or more processors, to cause the network node to identify the handover failure, the radio link failure, the secondary cell group radio link failure, or the primary secondary cell change failure, are configured to cause the network node to identify the handover failure or the radio link failure in accordance with detecting the subsequent conditional handover configuration formulation error during the subsequent conditional handover, and wherein the one or more processors, to cause the network node to transmit the selective secondary cell group activation failure indicator, are configured to cause the network node to identify the secondary cell group radio link failure or the primary secondary cell change failure in accordance with detecting a selective secondary cell group activation configuration formulation error during a conditional primary secondary cell change.

13. The network node of claim 12, wherein the one or more processors, to cause the network node to transmit the subsequent conditional handover failure indicator, are configured to cause the network node to transmit the subsequent conditional handover failure indicator from a master node associated with the network node to one or more candidate master nodes, wherein a root cause analysis is performed at the master node or the one or more candidate master nodes in accordance with a subsequent conditional handover configuration being determined by the master node or the one or more candidate master nodes.

14. The network node of claim 12, wherein the one or more processors, to cause the network node to transmit the selective secondary cell group activation failure indicator, are configured to cause the network node to transmit the selective secondary cell group activation failure indicator from master node associated with the network node to one or more candidate secondary nodes, wherein a root cause analysis is performed at the master node or the one or more candidate secondary nodes in accordance with a selective secondary cell group activation failure being determined by the master node and the one or more candidate secondary nodes.

15. The network node of claim 12, wherein the one or more processors, to cause the network node to transmit the selective secondary cell group activation failure indicator, are configured to cause the network node to transmit the selective secondary cell group activation failure indicator from a source secondary node associated with the network node to one or more candidate secondary nodes, wherein a root cause analysis is performed at the source secondary node and the one or more candidate secondary nodes in accordance with a selective secondary cell group activation failure being determined by the source secondary node and the one or more candidate secondary nodes.

16. A user equipment (UE) for wireless communication, comprising:
one or more memories; and
one or more processors, coupled to the one or more memories, the one or more processors individually or collectively configured to cause the UE to:
obtain an indication to perform a conditional handover in accordance with a conditional handover configuration with a plurality of conditional primary secondary cell change configurations or a plurality of conditional primary secondary cell addition configurations;
initiate the conditional handover and at least one of a conditional primary secondary cell change associated with the plurality of conditional primary secondary cell change configurations or a conditional primary secondary cell addition associated with the plurality of conditional primary secondary cell addition configurations;
detect a failure occurrence associated with the conditional handover, or at least one of the conditional primary secondary cell change or the conditional primary secondary cell addition; and
transmit, in accordance with detecting the failure occurrence associated with the conditional handover, or at least one of the conditional primary secondary cell change or the conditional primary secondary cell addition, information associated with a conditional handover configuration with the plurality of conditional primary secondary cell change configurations or the plurality of conditional primary secondary cell addition configurations.

17. The UE of claim 16, wherein the one or more processors, to cause the UE to transmit the information associated with the conditional handover configuration, are configured to cause the UE to transmit, in accordance with detecting a radio link failure, information associated with the conditional handover configuration that includes the plurality of conditional primary secondary cell change configurations.

18. The UE of claim 17, wherein the one or more processors, to cause the UE to transmit the information associated with the conditional handover configuration, are configured to cause the UE to transmit, for each conditional primary cell change configuration of the plurality of conditional primary secondary cell change configurations, at least one of:
an indication of whether an execution condition for a primary cell identifier has been satisfied;
an indication of an execution event that has been satisfied for a primary cell identifier or a primary secondary cell identifier;
an indication of a time gap between two or more configured events that have been satisfied for a primary cell identifier or a primary secondary cell identifier;
an indication of whether an execution condition for a primary secondary serving cell identifier has been satisfied; or
an indication of one or more conditional handover execution conditions, one or more primary secondary cell change execution conditions, or one or more conditional primary cell addition execution conditions.

19. The UE of claim 17, wherein the one or more processors, to cause the UE to transmit the information associated with the conditional handover configuration, are configured to cause the UE to transmit timing information that indicates at least one of:
a time between a radio link failure and a trigger condition associated with at least one of a condition handover, a conditional primary secondary cell change, or a conditional primacy secondary cell addition being satisfied; or
a time between a conditional handover execution condition being satisfied and a conditional primary secondary cell change or conditional primary secondary cell addition execution condition being satisfied.

20. The UE of claim 17, wherein the one or more processors, to cause the UE to transmit the information associated with the conditional handover configuration, are configured to cause the UE to transmit measurement information that indicates one or more primary cell measurements and one or more primary secondary cell measurements.

21. The UE of claim 17, wherein the one or more processors, to cause the UE to transmit the information associated with the conditional handover configuration, are configured to cause the UE to transmit an indication of whether a legacy conditional handover only is configured or whether a legacy conditional handover with secondary cell group is configured.

22. The UE of claim 17, wherein the one or more processors, to cause the UE to transmit the information associated with the conditional handover configuration, are configured to cause the UE to transmit secondary cell group failure information to a target master node after a successful handover, and wherein the one or more processors are further configured to cause the UE to transmit an indication of a most recent primary secondary cell change associated with the conditional handover.

23. A user equipment (UE) for wireless communication, comprising:
one or more memories; and
one or more processors, coupled to the one or more memories, the one or more processors individually or collectively configured to cause the UE to:
identify an error during a conditional handover execution with a plurality of conditional primary secondary cell changes or a plurality of conditional primary secondary cell additions; and
transmit information that indicates the error during the conditional handover execution with the plurality of conditional primary secondary cell changes or the plurality of conditional primary secondary cell additions.

24. The UE of claim 23, wherein the one or more processors, to cause the UE to identify the error during the conditional handover execution with the plurality of conditional primary secondary cell changes or the plurality of conditional primary secondary cell additions, are configured to cause the UE to identify that a conditional handover and at least one of a conditional primary secondary cell change or a conditional primary secondary cell addition were not performed, wherein the conditional handover or the conditional primary secondary cell change or conditional primary secondary cell addition was not performed based at least in part on execution conditions for the conditional handover and the conditional primary secondary cell change or conditional primary secondary cell addition failure were not satisfied within a configured time span.

25. The UE of claim 23, wherein the one or more processors are further configured to cause the UE to:
select, in accordance with performing a handover, a legacy conditional handover only configuration or a legacy conditional handover with a secondary cell group configuration; and
generate a successful handover report in accordance with completing the handover, wherein transmitting the information that indicates the error during the conditional handover execution with the plurality of conditional primary secondary cell changes or the plurality of conditional primary secondary cell additions comprises transmitting a successful handover report that includes information for optimizing a conditional handover configuration with the plurality of conditional primary secondary cell changes or the plurality of conditional primary secondary cell additions.

26. The UE of claim 23, wherein the one or more processors are further configured to cause the UE to:
detect a radio link failure; and
generate a radio link failure report, wherein transmitting the information that indicates the error during the conditional handover execution with the plurality of conditional primary secondary cell changes or the plurality of conditional primary secondary cell additions, comprises transmitting a radio link failure report that includes information for optimizing a conditional handover configuration with the plurality of conditional primary secondary cell changes or the plurality of conditional primary secondary cell additions.

27. The UE of claim 23, wherein the one or more processors, to cause the UE to identify the error during the conditional handover execution with the plurality of conditional primary secondary cell changes or the plurality of conditional primary secondary cell additions, are configured to cause the UE to identify that the conditional handover execution and a conditional primary secondary cell change or conditional primary secondary cell addition execution resulted in conditional handover failure, conditional primary secondary cell change failure, or conditional primary secondary cell addition failure, wherein a conditional handover failure or radio link failure is identified after a successful conditional handover is detected on primary cell and a measurement indicates that a source primary cell is a suitable cell, or wherein a primary secondary cell addition or change failure or a secondary cell group radio link failure is identified after a successful conditional primary secondary cell change or conditional primary secondary cell addition based at least in part on a measurement indicating that a source primary secondary cell is a suitable cell.

28. The UE of claim 27, wherein the one or more processors are further configured to cause the UE to:
detect a secondary cell group failure, wherein transmitting the information that indicates the error during the conditional handover execution with the plurality of conditional primary secondary cell changes or the plurality of conditional primary secondary cell additions comprises transmitting a secondary cell group failure indication to a target primary cell after a successful conditional handover that includes the information that indicates the error during the conditional handover execution with the plurality of conditional primary secondary cell changes or the plurality of conditional primary secondary cell additions; or
detect a radio link failure, wherein transmitting the information that indicates the error during the conditional handover execution with the plurality of conditional primary secondary cell changes or the plurality of conditional primary secondary cell additions comprises transmitting a radio link failure indication that includes the information that indicates the error during the conditional handover execution with the plurality of conditional primary secondary cell changes or the plurality of conditional primary secondary cell additions.

29. The UE of claim 23, wherein the one or more processors, to cause the UE to identify the error during the conditional handover execution with the plurality of conditional primary secondary cell changes or the plurality of conditional primary secondary cell additions, are configured to cause the UE to identify a conditional handover to an incorrect primary cell or identifying a conditional primary secondary change or addition to an incorrect primary secondary cell, wherein a conditional handover failure or radio link failure is detected after a successful conditional handover based at least in part on a primary cell measurement indicating that another primary cell other than a source primary cell and a target primary cell is a suitable cell, or wherein a primary secondary cell change or addition failure or a secondary cell group radio link failure is identified after a successful conditional primary secondary cell change or conditional primary secondary cell addition based at least in part on a primary secondary cell measurement indicating that another primary secondary cell other than a source primary cell and a target primary secondary cell is a suitable cell.

30. The UE of claim 23, wherein the one or more processors are further configured to cause the UE to:
transmit a received secondary cell group failure information report to a source primary cell, wherein a root cause analysis is performed at a target primary cell based at least in part on the received secondary cell group failure information report; or
transmit a received radio link failure report to a source primary cell or a target primary cell for root cause analysis.
